(19) United States
(12) Patent Application Publication
(10) Pub. No.: US 2021/0106040 A1
(43) Pub. Date: Apr. 15, 2021

(54) METHOD FOR DISINTEGRATING/SEPARATING AND DECOMPOSING PLANT SHELL MATERIALS AND CONSTITUENTS IN ORDER TO OBTAIN AND PRODUCE PLANT INGREDIENTS AND PLANT FIBER PRODUCTS

(71) Applicant: Max Dietz, Wiesbaden (DE)

(72) Inventor: Max Dietz, Wiesbaden (DE)

(21) Appl. No.: 16/498,468

(22) PCT Filed: Mar. 27, 2018
(86) PCT No.: PCT/EP2018/057838

§ 371 Date: Sep. 27, 2019

(30) Foreign Application Priority Data
Mar. 28, 2017 (DE) 10 2017 003 177.0

(51) Int. Cl. A23N 7/01; A23N 5/00; A21D 2/36; A21D 2/18; A23J 1/00; A23J 1/12; A23J 1/14

(52) U.S. Cl. CPC A23N 7/01; A23N 5/00; A21D 2/36; A23J 1/14; A23J 1/006; A23J 1/12; A21D 2/188

(57) ABSTRACT

The invention relates to a method for disintegration and unlocking of plant-based starting material with the method steps
a) providing a plant-based starting material,
b) adding a disintegration solution to the starting material and leaving it in the disintegration solution until disintegration,
c) dispensing of the constituents of the disintegrated starting material in a dispensing volume
to obtain solid constituents and dissolved constituents of the plant-based starting material,
d) separation of solid constituents from dissolved constituents of the plant-based starting material,
e) obtaining the separated constituents of the plant-based starting material as materials for further utilization by,
e1) Fractionating of cellulose-based fibers from lignin-rich shells of the solid constituents of the plant-based starting material by means of an cyclone separation technique to obtain purified fractions of cellulose-based fibers and lignin-rich shells,
e2) aggregation/complexation of dissolved proteins of the dissolved constituents of the plant starting material by complexing agents and separation of the sedimented aggregated/complexed condensed proteins to obtain an aggregated/complexed protein mass.

### BACKGROUND

Almost all plant products used for reproduction, such as seeds, kernels or grains, but also other plant products, such as fruits, are enclosed by at least one cladding structures (e.g. seed envelope, seed coat) to counteract activation and/or enhancement of activation/initiation of a growth process, and to preserve them and/or provide nutrients needed for growth and/or enable structuring. This is accomplished by providing such cladding layers as a completely closed shield against physical or chemical alterations. The seed coat has the task of providing water and nutrients in the developmental stage of the plant products and is the site where the constituents contained in seeds or grains, such as proteins, carbohydrates, and fats/oils are formed. Thus, such envelope layers contain a variety of enzymes, as well as compounds responsible for producing the constituents of the contents they enclose. Therefore, for example, high concentrations of starting and precursor compounds of these constituents, such as carboxylic acids (e.g., ascorbic acid or cinnamic acid) or enzymes or antioxidants or dyes, are also present in these cladding materials. Furthermore, compounds are also synthesized or incorporated by the cladding layers which are intended to counteract decomposition/attack by microorganisms or macro-organisms. These include, for example, odor or flavoring substances as well as toxins. When the ripening of the plant products is completed, the cladding layers are compacted and the nutrient supply is stopped. The compaction is different in the different seeds and kernels. In most cases, a crosslinking of lignin and/or cellulose into a compact and continuous layer occurs. As a result, the water-conducting capillaries located therein are closed. The plant products thereby receive mechanical protection against disintegration and protection against swelling of the enclosed constituents, but also against water loss. In the dried state, such cladding layers are compacted in a gap-free manner with the enclosed mass. Therefore, the cladding layers of plant products intended for reproduction are very difficult or impossible to separate by physical means from the enclosed constituents. This applies in particular to the cladding layer which directly adjoins the enclosed constituent. Physical separability is not possible in particular when the cladding layer is very thin and has similar physical properties, such as the elasticity or density, of the enclosed constituents. This is true for i. e. the shell skin (seed coat) of walnuts or soybeans, where a selective removal of the cladding layer by purely mechanical means is not possible after drying.

Seeds, kernels and grains of plants are important basic food resources and are provided partially crushed or completely crushed and/or in fractions thereof as food. For many of the seeds and grains, it is necessary to completely remove one or all of the cladding layers because there are undesirable effects if they remain in a foodstuff. This can lead to disturbing sensory effects, such as a bitter taste or lead to discoloration of the obtained product or the mouthfeel is unfavorably altered when consumed, due to particles that arise during further processing, including particle dimensions and hardness of the cladding material that is different from the other constituents of the plant products. Many of these cladding layers can be swollen by water absorption, whereby a water-filled gap space forms between the cladding layer and the enclosed mass of constituents. It is known that such a swelling in a water bath at room temperature forms only very slowly or not at all; however, using hot water or water steam this process can be significantly accelerated or initiated. Advantageously, heating also destroys and/or inactivates organic compounds which have toxic and/or anti-nutritive properties, such as ureases or thrypsin inhibitors. However, this can result to changes of the organic constituents giving them an undesirable sensory effects, such as a bitter taste or an astringent effect, which generally cannot be removed by heating and remain in the seeds grains or seeds even if it is freed from the cladding materials. The disadvantage of moist heating is that several undesirable effects can occur. On the one hand, proteins present in the treated plant seeds and grains are at least partially denatured and healthy organic compounds, such as vitamins, are inactivated. On the other hand, there is a greater swelling of the contained starch. Furthermore, fatty acids can be chemically modified so that, for example, trans-fatty acids or epoxides are formed, which have harmful effects. Therefore, methods for allowing separation of cladding materials at room temperature or only low heating are preferable to methods that heat the plant-based materials.

In the prior art, no methods are known with which a complete and easy to perform separation of cladding materials of plant seeds and kernels can be accomplished at room temperature or even reduced temperature. In particular, there is no report as to how maturation of the seedling or budding can be prevented, at room temperature or slightly elevated temperature, when storing plant products for reproduction in an aqueous medium. Therefore, there is a need for methods that allow complete and easy removal of cladding material from plant-based skins shells or husks without inducing initiation of seed, grain or kernel ripening, nor leading to alteration of the contained constituents or development of harmful/toxic compounds.

In many seeds, kernels and grains, the constituents also contain root forming parts, the so-called seedlings or sprouts. In many cases, their presence in the product to be provided for human nutrition is undesirable and/or there is an interest in obtaining these seedlings or root forming parts as a fraction for further utilization, e.g. for the production of a germ oil. Therefore, the separation of seedlings and/or root forming parts is desirable in many areas. In order to do this, the cladding layers must be removed because the seedlings and root forming parts are structurally linked to the remaining constituents of the seeds or kernels and are located within the innermost cladding layer.

In prior art processes, seedlings are separated by mechanical methods in which the seedlings are removed by crushing. This inevitably leads to injuries/breaking off of the constituents of the seeds, grains or kernels and to the entry or co-discharge of fragments of the cladding material. From the prior art, no methods are known with which these structures can be separated from each other under mild conditions and while maintaining the integrity of the separated seedlings/root forming parts and the remaining constituents of the seeds, grains or kernels. In particular, there is no method by which seedlings/root forming parts can be separated from the remaining constituents of seeds, kernels and grains under gentle (product-sparing) conditions with a simultaneous gentle and complete separation of the cladding materials, so that the various fractions can be easily obtained in a selected and in unaltered form. Therefore, it is desirable to have a process capable of satisfying these conditions and disintegrates plant seeds and kernels and preserves the separated shell material in a usable condition for further use.

Of economic interest are also coats, shells or husks, not suitable for human nutrition which are separated from plant seeds and kernels. Some of these are produced in large quantities, such as in the processing of rice or sunflower seeds. This cladding material usually has no nutritive value, since it is predominantly of cellulose and/or lignins in the form of high molecular weight compounds and therefore can not be digested by humans. Furthermore, as previously described, organic or inorganic compounds are often included or firmly adherent which cause unpleasant taste or odor or color, or are toxic or anti-nutritive. On the other hand, organic compounds may be contained or adherent which have health-promoting effects and whose presence in a food is desired. Therefore, there is also an interest in making the nutritive parts of seed coats, shells or husks accessible in a suitable form for human nutrition. Plant cladding materials are used in the form obtainable according to the state of the art as animal feed, soil fertilizer or starting material for fermentation processes. Methods which make it possible to treat cladding material in such a way that it is usable for human nutrition without causing any undesirable sensory or nutritive effects, as well as containing and maintaining health-promoting compounds, are not known in the prior art. Thus, there is a need to disintegrate or unlock plant cladding material so that it can be freed/separated from unwanted constituents/compounds and can be converted into a physical form that is suitable for human consumption.

Surprisingly, a process has been found which allows both a gentle (product-sparing) removal of cladding materials of plant seeds and grains, while maintaining the integrity of the constituents, as well as a gentle (product-sparing) separation of seedlings/root forming parts. In addition, with the method the cladding material, in which toxins and/or anti-nutritive compounds and/or compounds which cause sensorially undesirable effects are inactivated and/or removed due to the production conditions and/or neutralized, can be disintegrated and removed from the remaining constituents of the starting material.

Furthermore, surprisingly, a method can be provided with which the separated cladding material can be disintegrated and unlocked, resulting in new advantageous applications for separated or unlocked cladding materials.

Cellulose-based fibers make up the major constituent of non-digestible carbohydrates of plant-based materials used for consumption and essentially represent the bulk of dietary fiber. Non-digestible means that these compounds can not be cleaved by enzymes of the human gastrointestinal tract, such as amylases, and thus cleavage into C-6-sugar compounds that are absorbable is not possible. Thus, the cellulose-based fibers remain essentially as unchanged constituents in the intestinal tract and are thus constituents of the stool. In particular, due to their ability to bind water they are a very important regulator of the consistency of the colon content. This also determines the passage time of the resulting feces. The importance of a high-fiber diet for the prevention of bowel disease and intestinal transit problems has been clearly demonstrated in a large number of clinical studies. It was thus shown that the rate of bowl-carcinomas can be reduced by a high-fiber diet. Furthermore, a reduction of elevated cholesterol levels and associated cardiovascular diseases was demonstrated. Also documented is the stool-regulating function of dietary fiber-rich diets in chronic constipation, which is particularly prevalent in the older people. In addition, pro-biotic effects resulting from the partial degradation of cellulose-based fibers by the microbiome of the human colon have also been documented. Such effects are also attributed to a lower incidence of carcinoma developing outside the colon, mediated e.g. by short-chain fatty acids or phytosterols that arise or they are released from microbial degradation of the cellulose-based fibers, and which can pass through the colon wall. It is strongly recommended by world health associations and the FDA to consume dietary fiber in an amount of 30 g (dry matter weight) per day. This goal is not achieved in the vast majority of the forms of nutrition practiced in industrialized nations as well as in emerging economies. There is an inverse correlation between dietary fiber consumption and the incidence and severity of obesity and diabetes mellitus and, consequently, mortality. However, recommendations on dietary fiber content of the diet are not feasible in daily practice for various reasons, such as unavailability for the working people or implied social behavior, despite all the information and explanations available for this purpose. Thus, there is a great need to provide dietary fiber that can be added to or used to supplement food preparations that meet the sensory and functional requirements of a food product, thereby increasing the percentage of dietary fiber by weight.

Surprisingly, it has been found that the process according to the invention for the disintegration of plant cladding materials and peels also results in the unlocking of the remaining constituents of a plant starting material, in particular grains, kernels and nuts, but also other plant products.

Thus, it has been found that by disintegrating cladding material such as seed coats or shells according to the present invention which also accomplishes complete unlocking or separation of other constituents of the plant starting material from the cladding materials such as husks or peels, the soluble constituents of the plant starting material become hydrated and can then be easily removed in an aqueous dispensing volume where they are completely removed/detached and separated from the cladding materials. Further positive properties were then found for the recoverability of dissolved soluble organic compounds. Thus, an aggregation method has been found, with which it is very easy to aggregate and condense the dissolved soluble organic compounds, in particular proteins and carbohydrates, whereby they can be separated by known process techniques and can be obtained as pure fractions.

### DESCRIPTION

The invention relates to a method in which a disintegration of plant cladding materials is effected, which accomplishes an acceleration of the softening of plant cladding materials over prior art methods and under mild/gentle (product-sparing) conditions.

Mild means in this context that the separable cladding material and the remaining constituents of the starting material, in particular of kernels, grains and nuts, maintain their integrity, so they preferably remain physically intact, e.g. no fragmentation occurs.

Gentle on the product also means that mechanical alteration takes place to a significantly lesser extent than is the case with prior art processes. Gentle on the product means also that a temperature increase is limited to preferably <120° C., more preferably <100° C., more preferably <90° C., more preferably <75° C., more preferably <60° C., further preferably <50° C., and even more preferably <40° C. Furthermore gentle on the product also means that in an unlocking process in which higher temperatures are used, for example, organic compounds, in particular cellulose-based fibers and lignin-rich shells can be obtained without requiring mechanical comminution of these or the starting material. Thus, in the different embodiments of the method, different product-sparing effects can be achieved, which have a direct influence on the obtainable products and/or the process economics. The method is particularly suitable for being able to carry out a complete separation of the cladding materials from other constituents of a plant starting material without harming or disintegrating the structural integrity of the plant product enclosed by the cladding material in its entirety. In a preferred embodiment, this is ensured by placing the seeds, grains or kernels, in which a separation of the cladding material is desired, into a solution containing soluble compounds used for the disintegration. In one embodiment, the disintegration compounds are cationic amino acids and or peptides. Surprisingly, it has been found that this leads to a rapid onset of hydration of plant cladding materials already at room temperature or reduced temperatures, which is significantly faster and more complete than with an aqueous solution containing compounds known in the art, such as NaOH.

It has also been found that plant cladding materials that have been disintegrated and hydrated by one of the methods of the present invention are much easier to remove than this is possible by treatment with other aqueous-solubilized compounds. Surprisingly, it has been found that during the disintegration and hydration according to the invention of the plant-based cladding material in seeds and grains, depending on the plant species, a thinning/dissolution occurs in which then a perforation of the cladding material occurs spontaneously or by a slight mechanical alteration which takes place always at the same spot or in the same area of the cladding layer. From there, the rupture can be continued, using slight mechanical shearing of the cladding structures, while the integrity of the entire remaining cladding material is maintained. It has been found that, depending on the duration of exposition and concentration of the amino acids/peptides, complete perforation occurs spontaneously or by a very small input of mechanical energy, e.g. by applying shear stress, whereby the cladding material is detached from the seeds, grains or kernels completely and in one piece. It has been shown that reliable and complete removal of the cladding material can be ensured by one of the embodiments of the methods according to the invention. Preference is given to a method for a gentle, product-sparing disintegration/perforation or detachment of cladding material of plant seeds, grains or kernels.

Surprisingly, a virtually selective disintegration of the plant cladding material can be achieved, with largely complete retention of the integrity of the remaining constituents of the seeds, grains or kernels, when placed in a solution containing dissolved amino acids and/or peptides under elevated temperature conditions. This leads to a spontaneous detachment of the cladding material. As expected, the disintegration process of the cladding material accelerates when heated to temperatures >80° or 90° C. Surprisingly, however, the time period required for this can be kept so short that there is no relevant swelling, disintegration or damage to the remaining constituents of the seeds, grains or kernels enclosed by the cladding material. Advantageously, thus, a selective disintegration of the plant cladding material can take place, under conditions that are gentle for the other constituents of the seeds, grains or kernels. In one embodiment, for this purpose, a solution according to the invention is heated with seeds, grains or kernels completely covered therein, preferably at temperatures of >70° C. Preferably, the seeds or kernels are agitated during the process. It could be shown that under these conditions a complete detachment of the cladding materials occurs. Again, the cladding material retained its integrity except for the spot or areas of perforation. Surprisingly, it was found that the seeds or kernels in the solutions containing dissolved amino acids and/or peptides swelled to the same extent under elevated temperatures, as was the case in a cold aqueous solution.

Preferred is a method for the complete detachment/separation of cladding material from plant seeds or kernels.

Preference is given to a process for disintegrating and unlocking of plant starting material, in which process step b) takes place together with thermal and/or mechanical disintegration or thermal and/or mechanical disintegration takes place in process step b1) following process step b).

Surprisingly, it has been found that with increasing concentration of the amino acids and/or peptides, there was a slowing down or complete suppression of germination/sprouting of the seeds, grains or kernels placed in such a solution. For example, soybeans, which were placed in a solution containing lysine at a concentration of 0.4 molar for more than 8 days, showed a volume increase of 160 vol % and a substantial detachment of the cladding layers, but no growth of seedlings. In contrast, soybeans that had been placed in water for the same period had sprouts of 2 to 4 cm in length; however, removal of cladding material was difficult and incomplete. Furthermore, those beans had a volume increase of 280 vol %. This effect could also be documented for other seeds and grains, for example with kidney beans. In addition, there was the very beneficial effect that can exploit utilization of seedlings/sprouts. It has been found that after detachment of the cladding material, which was achieved by an placing of the starting material into a unlocking solution according to the invention and which occurs spontaneously or by a slight mechanical alteration of the cladding material, and also in the presence of a slight swelling of the seed or grain, a seedling/sprout that had formed already and which is present in the germinal bed in detached form, could be very easily separated from the seed or grain. This could be achieved solely by passage of thus pretreated seeds or grains through a tube or sleeve, whereby both, the cladding material and the seedling/sprout were separated from the seed or grain. Thus, a mechanical separation of seedlings or sprouts can be considerably simplified.

Furthermore, seedlings or sprouts together with the disintegrated cladding material can be detached and separated from seeds or grains in a single operation.

Preference is given to a process for the disintegration and process for unlocking of plant-based starting material, in which apart from a disintegration and/or separation and/or dissolution of plant cladding materials, a separation of a seedling/sprout takes place.

Preferred is a method for easier separation of seedlings/sprouts.

Preferred is a process for disintegration and unlocking of plant starting material, in which there is a slowing/suppression of ripening of plant seeds and/or grains.

Surprisingly, it has been found that the seeds and grains which have been freed from the cladding material by one of the methods according to the invention can be further processed in a particularly advantageous manner. This concerns in particular the further processing to unlock the individual constituents of the seeds and grains. Thus, it could be shown that after an aqueous unlocking process grinding of seeds and grains in which the cladding materials have been removed according to the invention and a swelling of the plant material in a range between 100 and 200 vol % was present, using a flywheel mill allowed production of a fine-grained mass and complete separation into their constituents in a short time.

It is particularly advantageous that in comparison to an untreated seed or grain, a significantly lower energy input is required and there is no dust development during grinding. In this respect, one of the methods according to the invention is also directed to a disintegration and hydration of plant starting material, in which a disintegration/separation of cladding and/or shell materials takes place.

Preference is given to a method in which in addition to disintegration/separation of cladding and/or shell materials of a plant starting material, disintegration/hydration of the other constituents of the plant-based starting material also takes place. Preferred are seeds, grains and kernels. In further investigations it could be shown that in the case of seeds or grains which had been pretreated in this way, the individual constituents of these could be separated very easily by means of an aqueous process for unlocking individual constituents. In a preferred method embodiment, seeds or grains are completely freed from cladding/shell materials by one of the methods according to the invention and fed directly or in the course, in a still swollen state, to a grinding or crushing process, whereby a fine-grained mass without dust is obtained, which is exposed to a solution to unlock the components/constituents. In one embodiment, immediately after or after an unlocking phase, a separation of the solids takes place which is preferably accomplished by filtration. As a result, complex or complexed carbohydrates in the form of particles and cellulose-based fibers are preferably obtained with the filter residue, preferably these are completely or substantially completely freed from soluble constituents of the starting material, in particular of proteins and soluble carbohydrates. Furthermore, a largely or completely fiber-free aqueous solution containing dissolved soluble proteins and carbohydrates is obtained with the filtrate.

Surprisingly, the dissolved soluble compounds can be aggregated and condensed in a very advantageous manner, which makes them very easy to separate from the aqueous dispensing phase. Preferably, the protein fraction is selectively removed by condensation/aggregation/complexation and/or a filtration or centrifugal separation technique and obtained as a pure product. Such selective condensation/aggregation/complexation of the dissolved proteins can be achieved e.g. by the addition of an organic acid, such as citric acid or acetic acid.

Thus, by one of the methods of the present invention, both liberation of plant seeds and kernels from cladding/shell material, as well as separation of the resulting plant seeds, kernels, and grains into their constituents can be very easily accomplished. It could be shown that after a swelling of seeds, grains or kernels with an aqueous solution which did not contain any of the compounds according to the invention for disintegration, it was not possible to dispense the constituents of the seeds, grains or kernels, with a subsequent dispensing process into an aqueous volume of a dispensing solution. Surprisingly, a separation of the constituents which have been hydrated by the process according to the invention was achieved in an aqueous dispensing volume, if one of the solutions according to the invention containing substances for disintegration/unlocking has been used. Preferred compounds for disintegration/unlocking are amino acids and/or peptides. For a process, in which first a disintegration of the cladding material, combined with a swelling of the seeds, grains or kernels is achieved with the solutions according to the invention, which is followed by a mechanical disintegration thereafter, it could be shown that in contrast to methods in which a separation of the cladding/shells materials was done with another method for a complete unlocking of the constituents of the plant material, further exposure to an aqueous solution according to the invention, containing compounds for disintegration, is not required.

Thus, the process allows both, the disintegration and unlocking and separation of plant cladding/shells structures, as well as subsequent disintegration/unlocking of the remaining constituents of the starting material and their separation and recovery in one process execution. Thus, surprisingly, with an aqueous unlocking solution according to the invention both, a disintegration of plant cladding material and its separation of seeds, grains or kernels can be achieved, as well as a subsequent unlocking of the constituents of the seeds, grains or kernels are performed by an aqueous unlocking process.

Preference is given to a method in which an aqueous unlocking process and separation of the constituents of seeds, grains or kernels is made possible by disintegration and/or separation of the cladding material and/or swelling of the seed (s), grains or kernels by an aqueous solution containing dissolved amino acids and/or peptides.

Preferred is a method of separating plant cladding material while maintaining the structural integrity of the separated cladding materials and/or the constituents of the seed (s), grains or kernels.

Preference is given to a process for producing plant cladding material preparations for use as a pulp preparation.

Preference is given to plant cladding material preparation obtainable by a process for disintegrating and unlocking of plant starting material.

Preference is given to the use of the plant cladding material preparation for pulp preparations.

Preferred is a method for the unlocking of plant seeds, grains or kernels.

Surprisingly, disintegration of a plant starting material according to the invention also brings about the recoverability of constituents contained therein. In a preferred embodiment, the disintegration is carried out to obtain soluble proteins and carbohydrates as well as cellulose-based fibers and/or lignin-rich shells. In particular, for a disintegration with sulfites and urea according to the invention, in addition to a disintegration, an unlocking of seeds, grains and kernels could be effected, which leads to a complete solubilization of proteins by using the methods disclosed herein, which then exist in a dissolved state and which can be aggregated, condensed, separated and recovered. For example, it has been shown for soybean seeds that when they were submerged in an aqueous solution for disintegration in which sodium sulfite and/or urea dissolved at a concentration of 1% by weight, and the aqueous medium was heated to 125° C. at an atmospheric pressure of 1.4 bar, the constituents could be completely dispensed in an aqueous dispensing volume thereafter, when the suspension was passed through a colloid mill utilizing high shear stress. Filtration of the resulting aqueous dispensing phase allowed the recovery of a fraction of solid matter which was free from soluble residues according to microscopic analysis.

On the other hand, the dissolved proteins present in the filtered process liquid could be aggregated/complexed with aggregating/complexing compounds, allowing them to condense and sediment, and be separated from a free water phase by filtration or centrifugal separation techniques which were then present as a pasty creamy mass. In the chemical analysis, a protein concentration of 75% by weight was detected. A similar result could also be obtained for a disintegration of other plant starting materials, such as sunflower seeds, maize grits or jatropha and rapeseed press cake. Protein isolates or concentrates were readily obtained.

Thus, in a preferred method embodiment, disintegration is performed with or without one of an unlocking method according to the present invention in order to obtain soluble constituents of the plant starting material.

Thus, a method for disintegration and unlocking of plant starting material is preferred with the method steps
a) providing a plant starting material,
b) adding a disintegration solution to the starting material and leaving it in the disintegration solution until disintegration is achieved,
c) dispensing of the constituents of the disintegrated starting material in a dispensing volume,
d) separation of solid constituents from dissolved constituents of the starting material,
e) obtaining valuable fractions of separated constituents by,
e1) fractionating of cellulose-based fibers from lignin-rich shells by means of a cyclone separation technique and obtaining purified fractions of cellulose-based fibers and lignin-rich shells,
e2) aggregation/complexation of dissolved proteins by complexing agents and separation of sedimented aggregated/complexed condensed proteins to obtain an aggregated/complexed protein mass.

Optionally, process step b) may be performed together with a thermal and/or mechanical disintegration process or, alternatively, a thermal and/or mechanical disintegration may be carried out in optional process step b1) following process step b).

The solid constituents obtained by a disintegration process in which the amino acids and/or peptides according to the invention were not contained in the disintegration solution had a distinct type-typical odor. Therefore, a method for disintegration and unlocking of plant-based starting material with the method steps is preferred
a) providing a plant starting material,
b) adding the starting material with a disintegration solution containing amino acids and/or peptides and remain in the disintegration/unlocking solution until disintegration,
c) dispensing of the constituents of the disintegrated starting material in a dispensing volume,
d) separation of solid constituents from dissolved constituents of the starting material,
e) obtaining valuable fractions of separated constituents by,
e1) fractionating of cellulose-based fibers from lignin-rich shells by means of a cyclone separation technique and obtaining purified fractions of cellulose-based fibers and lignin-rich shells,
e2) aggregation/complexation of dissolved proteins by complexing agents and separation of sedimented aggregated/complexed condensed proteins to obtain an aggregated/complexed protein mass.

A preferred method embodiment is characterized by the following process steps: Process for the disintegration and unlocking of plant starting material with the process steps
a) providing a plant starting material,
b) placing the starting material with a disintegration solution and leave in the disintegration solution until disintegration,
c) dispensing of the constituents of the disintegrated starting material in a dispensing volume to obtain solid constituents and dissolved constituents of the plant starting material,
d) separation of solid constituents from dissolved constituents of the plant starting material,
e) obtaining the separated constituents of the plant starting material as value fraction by,
e1) fractionating of cellulose-based fibers from lignin-rich shells of the solid constituents of the plant starting material by means of a cyclone separation technique and obtaining purified fractions of cellulose-based fibers and lignin-rich shells,
e2) aggregation/complexation of dissolved proteins of the dissolved constituents of the plant starting material by complexing agent and separation of the sedimented aggregated/complexed condensed proteins to obtain an aggregated/complexed protein mass.

Optionally, process step b) may be performed together with a thermal and/or mechanical disintegration process or, alternatively, a thermal and/or mechanical disintegration may be carried out in optional process step b1) following process step b).

In comparative studies it was possible to show that using amino acids and/or peptides according to the invention, the obtainable cellulose-based fibers and/or lignin-rich shells were immediately free of odorants and/or flavorings.

It is furthermore particularly advantageous that the disintegrated cladding material can separated completely and in one piece from the plant seeds, grains or kernels. In a preferred embodiment, the separation of disintegrated cladding material/shells preferably takes place with a device which results in a one-sided or multi-sided tangential shear force on the plant seeds and grains prepared according to the invention.

The shearing force can be applied in the form of a pressure affecting on the outside of the plant seeds, grains or kernels or in the form of a shearing motion. Suitable devices known in the art are, for example, crimping presses. In a particularly preferred embodiment, the stripping of a cladding layer is achieved by first sorting the plant seeds, grains or kernels via a size-sorting device of the prior art into storage containers of defined diameter ranges of these seeds or kernels. From these storage containers, individual seeds, grains or kernels are placed in a funnel or shaft by another device so that the seeds or kernels arrange in a preferred longitudinal orientation. In a preferred embodiment, one or more seeds or kernels are pressed through a flexible sleeve/tube or one or more perforated septum/septa via a plunger or pneumatic device. Preferably, in this case, the cladding material is completely stripped off. Preferably, the plant seeds, grains or kernels are expelled/catapulted from the stripper due to the acceleration they have experienced and collected in another storage vessel. Preferably the cladding material is likewise ejected and separated by a different path compared to the seeds, grains or kernels trajectory, which have been liberated from the cladding material, which is accomplished for example by gravity or air classification and is thereby transported into another container.

In a further preferred embodiment, the cladding material is separated by a device in which the plant seeds, grains or kernels pretreated according to the present invention are either sorted by their diameter or unsorted on at least two approximately or completely parallel arranged tubes, rotating uniformly and/or non-uniformly and/or counter-rotating. The seeds, grains or kernels are rotated and transported in the gap formed by the tubes against each other. Preferably, there is a non-uniformity of rotation of at least one of the tubes or of several tubes. This results in a tangential shear force on the cladding material of the seeds, grains or kernels, which are rotated thus leading to the rupture of the cladding material, which is separated and transported by the rotational movement of the tubes. The separated cladding material of the seeds, grains or kernels can be discharged, i.e. by an acceleration movement and/or a jet of air. As a result, the seeds, grains or kernels that have been liberated from the cladding material and the cladding material can be collected in different containers.

A device is preferred to detach and separate disintegrated cladding materials and shells of seeds, grains or kernels by tangential shear forces acting on the disintegrated cladding material.

Preferred is a device for perforation/detachment/separation of cladding material of plant seeds, grains or kernels.

Surprisingly it has been found that by one of the methods according to the invention, layers (intermediate/connecting layer) which are present or are formed between the plant cladding material and the seeds, grains or kernels in order to connect them can be very easily removed in a very advantageous manner.

Thus, for example, in the separation of seed coats of almonds and soybeans, it has been found that when this was done using water or one of the methods of the invention and the swollen seed coat had been removed mechanically, a soapy viscous to mucous-like layer remains on the seeds, grains or kernels which became sticky during the course of drying and led to adhesion/sticking of the obtained seeds, grains or kernels. It has been found that the intermediate layer that has been swollen by a disintegrating solution according to the invention, and which is present on the surfaces of the exposed plant seeds, grains or kernels, but can also be present on the surfaces of the separated cladding materials, can be easily removed by rinsing with cold water. This was not possible if the intermediate layers had not been exposed using the methods according to the invention or only by a rinsing process which was carried out with hot water. The intermediate layer can be rinsed off for example with water. Thus, preferred is a disintegration/unlocking of intermediate layers/connecting layers of cladding and shell materials/layers of the plant starting material using of one of the aqueous solutions according to the invention containing compounds for disintegration. Particularly preferred are dissolved amino acids and/or peptides. However, it is also possible to use aqueous or alcoholic solutions which contain other compounds, the addition of ionic and/or nonionic surfactants being preferred. It is preferred to carry out the rinsing process with a device for the cleaning of objects from the prior art, such as the use of a bundled jet of water or steam or by the establishment of a movement of the plant material to be cleaned, establishing shearing forces of the cleaning material with each other and/or use of a mechanical mover, i.e. a washing machine. Surprisingly, it was found that plant seeds or kernels that have been treated/prepared in such a way exhibited a changed drying behavior. The drying process, i.e. of kidney beans or pumpkin seeds, was faster when the intermediate layer was detached and completely removed by a rinsing process after carrying out one of the inventive methods. It was found, for example in dried pumpkin seeds, that after removal of the intermediate layer according to the invention, no skin formed during drying. Furthermore, the isolation from each other of the pretreated seeds was much easier when a disintegration/separation of the intermediate layer has taken place.

Preference is given to a method for disintegrating/dissolving/detaching an intermediate layer between plant cladding material and plant seeds, grains and kernels. Preference is given to a process for the disintegration and unlocking of plant starting material, in which a disintegration/dissolution/detachment of an intermediate layer takes place between plant cladding material and plant seeds, grains and kernels.

Surprisingly, it has been found that with the methods according to the invention it is also possible to disintegrate/partly dissolve/detach adhesions and connecting structures of plant seeds and kernels. For example, it has been shown that the seeds of a pumpkin or a melon can be removed very easily and free of residues from the strand-like or septa-like tissue structures which supply and mechanically stabilize them via the adhering structures when the seeds or kernels had been treated together with one of the solutions according to the invention.

The easy removal of adherent tissue structures as described could not be achieved by treatment with water or aqueous solutions containing, for example, surfactants under otherwise comparable conditions.

Surprisingly seeds, grains or kernels which have been prepared by one of the processes according to the invention and have been contacted for a sufficiently long time with one of the liquids according to the invention containing cationic amino acids and/or peptides or have been stored herein have a markedly reduced or completely eliminated plant-characteristic taste. In additional investigations it could further be shown that the reduction or elimination of an unpleasant/astringent taste depends on the duration of exposure to the liquids of the invention for disintegration, containing cationic amino acids or peptides, or depends on the duration of a perforation of the cladding layer (s) of the plant seeds, grains or kernels. It has also been shown that the reduction or elimination of a characteristic taste of the species of the plant seeds or kernels treated with one of the methods according to the invention occurs after the removal of unpleasant/astringent sensory effects in a chronological sequence. As a result, undesirable sensory effects and a characteristic (intrinsic) taste of the treated plant seeds, grains or kernels can be eliminated or removed in a very advantageous manner with the methods according to the invention, either separately or combined with the cladding material. Thus, low-flavor or tasteless plant seeds, grains or kernels, which are intact in their integrity and are completely freed from a cladding layer, can be produced under conditions that are gentle on the product (product-sparing). It has been shown that this reduction of sensory perceptible constituents of plant seeds, grains or kernels, which is accomplished by exposure to the disintegration liquids according to the invention, containing cationic amino acids or peptides, has a significant effect on the recoverable products from such treated plant seeds, grains or kernels. For example, it has been shown that the constituents which can be obtained in separate unlocking processes in separate fractions, are completely or practically free of odors and flavors that result in a typical/intrinsic or unpleasant or astringent sensory effect. This is particularly advantageous for the recoverable starch and protein fractions.

Preference is given to a process for the disintegration/detachment/separation of plant claddings materials and for obtaining a low-odor and/or low-taste or odorless and/or flavor-free separated cladding material and/or plant product.

Preferred is a process for disintegration and unlocking of plant starting material, in which the disintegration solution contains amino acids and/or peptides.

Further advantageous effects of the method embodiments result from the separated cladding layers that are obtained. Surprisingly, it has been found that separated cladding layers which can be obtained are virtually free or nearly free from unpleasant taste or astringent sensory effects. In addition, the disintegrated plant cladding layers obtained according to the method are maximally swollen and easily moldable into any shape. For example, they can be shaped and/or pressed into sheets and can be cut to size without breakage. It has been found that, for example, thin strips or other geometric shapes can be cut off from cladding layers obtained in this way, in particular because the cladding layers can be pressed flat without breaking. By this effect, the recoverable and still swollen cladding layers can be compressed forming, i.e. sheets or films. It is furthermore advantageous that the separated cladding layers, which are obtained according to one of the disintegrative methods according to the invention, are free or practically free of an unpleasant taste or release substances which trigger an astringent sensory perception. Therefore, the obtained cladding layers can also be used for a food preparation. In particular, fibers which can also be obtained from cladding layers produced in this way are particularly suitable for texturing foods and food preparations. In addition, the obtainable disintegrated cladding materials have improved swellability compared to cladding material obtained by other techniques. Thus, the processes of the invention are particularly advantageously suitable for producing low-taste or taste-neutral textures of fibrous materials (pulp) having good processability and good swelling capacity. By the embodiments of the method according to the invention, products prepared from cladding material that can be used in various applications, e.g. for texturing food, can be obtained. Herein the term cladding material preparation means the fusion/composite/texture of disintegrated cladding materials which have been made moldable by a disintegration according to the invention.

Preferred is a method for producing textures of plant cladding material, which is low in taste or tasteless and/or can be combined to form flat and customized or ready-to-assemble sheets or films and/or are readily swellable.

Preference is given to a process for disintegrating and unlocking plant starting material, for producing fiber products, from plant cladding materials.

Preference is given to a process for disintegrating and unlocking plant starting material, for producing a plant cladding material preparation.

Preference is given to a process for the disintegration and unlocking of plant starting material, in which a gentle disintegration/perforation or detachment of cladding material of plant seeds, grains or kernels takes place.

Surprisingly, it has been shown that with one of the disintegration processes according to the invention, compacted plant cladding material can be unlocked, and the constituents of the cladding material made recoverable. It was found that plant cladding materials, which were placed in one of the aqueous solutions according to the invention for a long period of time, swelled and cellulose-based fibers could be removed layer by layer. It has also been found that the plant cladding materials quickly and completely dissolve when treated in one of the solutions of the invention in an autoclave under suitable temperature and pressure conditions. The resulting mass then consisted predominantly of unlocked cellulose-based fibers that could be easily purified with water from proteins and soluble carbohydrate compounds contained herein, using filtration techniques.

In this case, the cellulose-based fibers that were extracted from the hydrated cladding materials exhibited to some extent significantly different properties compared to the cellulose-based fibers that were obtained from the grains or kernels, which had been enclosed previously by the cladding material treated with the above-described aqueous unlocking process. The cellulose-based fibers obtainable from disintegration and unlocking of the cladding material differ, for example, in size and shape. Thus, the cellulose-based fibers obtained from the unlocking process of the cladding material had a larger aspect ratio of the longitudinal/transverse dimensions than those after disintegration and unlocking of the remaining constituents of the seeds, grains or kernels. It is believed that these differences are also responsible for the different sensory perceptions found for the cellulose-based fibers of the seeds, grains or kernels and those of the corresponding unlocked cladding material. Further, cellulose-based fibers obtainable from cladding materials had other functional properties than the cellulose-based fibers obtained from disintegration/unlocking of plant seeds, grains or kernels. For example, heavily pigmented cellulose-based fibers were obtained from the unlocked cladding material of kidney beans. Furthermore, for example, the disintegrated and unlocked husks of dried almonds and avocado kernels had a particularly smooth feeling of melting during the tasting. Moreover, in the production of doughs and food preparations, such cellulose-based fibers have better emulsifying and stabilizing properties than cellulose fibers.

Preference is given to a process for obtaining cellulose-based fibers from cladding material of plant seeds, grains or kernels.

It has also been shown that carbonates and sulfites are suitable for the disintegration of cellulose-based fibers. If basic compounds for disintegration were used in plant starting materials which, in addition to cellulose-based fibers and/or lignin-rich shells, also contained proteins as well as soluble carbohydrates, intensive browning of the solutions and the disintegrated plant material occurred, which is undesirable. Surprisingly, it has been found that when already an unlocking process of the starting material has taken place and in particular, if a separation of dissolved or soluble proteins and carbohydrates has already taken place, a discoloration, which leads to a deterioration of cellulose-based fibers, does not take place when carbonates or sulfites are contained in the aqueous unlocking medium. Thus, for example, in a disintegration of soybean meal containing a 1 wt % urea solution containing arginine in a 0.05 molar concentration, complete disintegration of the cladding material after heating to 90° C. for 60 minutes could be achieved. It was also achieved an unlocking result, which allowed a nearly complete separation of soluble proteins and carbohydrates, which were filtered off with the process liquid. The resultant optically bright fiber mass was tasteless and odorless and contained cellulose-based fibers of that 38 wt % (DM) were less than 100 μm, 82 wt % (DM) were <250, and 18 wt % (DM) were >250 μm. The fiber mass was further disintegrated with a 0.5% by weight sodium carbonate solution at 80° C. for 20 minutes, whereby in each case no discoloration of the process fluid or the cellulose-based fibers occurred.

The subsequently obtained cellulose-based fibers were sensorially softer than before the further disintegration and were in up to 65% by weight (DM)<100 μm, and in up to 98% by weight (DM)<250 μm. The fiber material that was obtained had an excellent mouthfeel during the tasting, which was described as creamy and smooth. Therefore, according to the invention, a two-stage disintegration/unlocking process can also to be carried out, in which first a disintegration/disruption of cladding/shell material takes place with a separation of dissolved soluble constituents of the starting material and then a disintegration of cellulose-based fibers and/or lignin-rich shells is performed. Surprisingly, it has been found that solutions containing sulfites are likewise suitable for effecting disintegration of cellulose-based fibers. Thus, it could be shown that marc (brewers grains), which contains only small amounts of soluble proteins and carbohydrates after fermentative digestion and which was disintegrated in a 1 wt % aqueous sodium sulfite solution at 85° C. for 90 minutes, and dispensed by means of a colloid mill obtaining a suspension of dispensed cellulose-based fibers. The obtained cellulose-based fibers were sensory very soft, being 78% by weight (DM)<100 μm, and to >95% by weight (DM)<250 μm.

Preference is given to a process for obtaining cellulose-based fibers from cladding material of plant seeds, grains or kernels.

Furthermore, it has been found that aroma- and/or colorant-free cellulose-based fibers can also be produced by the compounds suitable for disintegration/unlocking according to the invention. Thus, for sugar beet pulp after molasses extraction, which had only a low residual content of soluble carbohydrates, a disintegration carried out using a 1% sodium bisulfite solution or a 2% sodium bicarbonate solution at 90° C. for 90 minutes and then the disintegrated pulpy mass was treated by means of a shear mixer, thus resulting in a suspension of cellulose-based fibers. However, the fiber masses still had a strong earthy smell and taste and were therefore not suitable for consumption. By further unlocking process with solutions of the amino acids and/or peptides according to the invention, in which the dewatered fiber mass was submerged for 60 minutes at 50° C., and again dehydrated and rinsed thereafter, the resultant cellulose-based fibers were odorless and tasteless and were rated as very soft and creamy at the sensory examination. Further, in the sieve analysis, it was found that the cellulose-based fibers were <100 μm in 80 and 85 wt % (DM) and were <250 μm in 94 and 96 wt % (DM), respectively.

Further investigations into the use of cellulose-based fibers have shown that very good sensory (for example creaminess) and functional qualities, such as the swelling volume, can be achieved in particular if a disintegration and an unlocking process of soluble constituents of the starting material have taken place, with a low residual content of soluble carbohydrates and proteins and other soluble organic compounds in the obtained cellulose-based fibers. Therefore, a method for disintegration and unlocking of plant material is preferred which guarantees that the residual content of readily water-soluble organic compounds in cellulose-based fibers is preferably <5% by weight, more preferably <2.5% by weight and more preferably <1.0% by weight.

Preferred is a process for disintegrating cellulose-based fibers and unlocking and separating soluble constituents contained therein.

Preference is given to a process for disintegrating cellulose-based fibers and unlocking and separation of soluble constituents contained therein, in which odorless and/or tasteless cellulose-based fibers are obtained, with a residual content of <5% by weight of readily water-soluble organic compounds.

Preference is given to a process according to the invention wherein the readily water-soluble organic compounds have a water solubility of >100 g/L at 20° C., preferably >140 g/L at 20° C., and the sparingly water-soluble organic compounds have a water solubility of <100 g/L at 20° C., preferably of <75 g/L at 20° C.

Preference is given to a process for disintegration of cellulose-based fibers and unlocking and separation of soluble constituents contained therein, to obtain odorless and/or tasteless cellulose-based fibers, with a residual content of <5% by weight of readily water-soluble organic compounds, in which the aqueous disintegration solution (s) contains sulfites and/or carbonates.

It has further been found that the sensory and functional properties of the cellulose-based fibers are present when decompaction has occurred through the disintegration/unlocking process and the decompaction is associated with the solubilization of soluble constituents complexed with the cellulose-based fibers. A corresponding decompaction was also found for the lignin-rich shells obtainable by a process according to the invention.

Preference is given to a process for disintegration and unlocking of plant starting material, in which a decompaction of cellulose-based fibers and/or lignin-rich shells is prepared.

Furthermore, it was surprisingly found that compacted and lignin-containing shell material can also be disintegrated and unlocked with one of the methods according to the invention and the leachable cellulose-based fibers can be made recoverable. It has been found that the addition of additives is suitable for disintegrating and/or splitting up or even completely dissolving lignin-containing structures which hinder the disintegration of cellulose-based fibers. In this case, the combination of the aqueous solutions according to the invention containing dissolved amino acids and/or peptides, together with the unlocking additives according to the invention proved to be crucial for the recoverability of the cellulose-based fibers in lignin-containing plant cladding materials and the dissolution of lignin polymers under mild product conditions. In this case, a disintegration of lignin polymer structures can already be achieved at a moderately elevated temperatures in the range of 60-80° C. It has been found that by using elevated pressures at temperatures between 90° and 140° C., disintegration/unlocking can be significantly accelerated, especially with simultaneous pressurization, as is possible in an autoclave.

The cellulose-based fibers remain structurally preserved and have a particularly low sensory perceptible hardness. Furthermore, it has been found that these fibers have a particularly low fiber length weight of <50 mg/100 m. These cellulose-based fibers also have very good sensory properties, such as a smooth melting mouthfeel. Surprisingly, cellulose-based fibers could also be obtained, for example, from the fiber material of coconuts and from orange peels using such a disintegrative process technology. Suitable additives for a solution and/or dissolution of lignin or lignin containing polymer structures, which are suitable together or in sequential order with the aqueous solutions of this invention and can be used individually or in combination with each other, are preferably sulfite compounds such as sodium sulfite or sodium bisulfite, also sulfate compounds, such as Na₂SO₄, furthermore urea and urea derivatives, such as thiourea, also detergents, such as sodium lauryl sulfate, furthermore carbonates, such as sodium carbonate.

Preference is given to a process for disintegrating/unlocking lignin-containing structures and recovering lignin-rich cladding fractions and cellulose-based fibers.

Preferred is a method for the dissolution of plant cladding material.

Preferably, lignin-containing cladding material is obtainable by a process for disintegrating and unlocking plant starting material.

Surprisingly, it has been found that plant cellulose-based fibers from various plant products which are not suitable for food preparation can be extracted and purified from plant waste materials and obtained by the inventive method to provide odorless and tasteless cellulose-based fibers which have excellent functional properties for the preparation of food preparations and at the same time have positive stool-regulatory properties. It is therefore also the object of the invention to provide processes and methods for obtaining and providing functional or functionalizable cellulose-based fibers.

Thus, it has been shown that the use of cellulose-based fibers for the production of flour-based and/or starch-based foods, flour or starch can be saved in the same order as the addition of cellulose-based fibers, without affecting the quantitative or qualitative baking results. Coating cellulose-based fibers with a leavening agent, such as yeast or sodium bicarbonate, onto their inner surfaces results in an increase in the baking volume and a more uniform distribution of the air chambers formed compared to an original formulation. At the same time, the baked goods prepared with cellulose-based fibers had a higher resistance to indentations as compared baked goods prepared with the reference recipe and resulted in an improved mouthfeel and a more harmonious taste sensation.

It has also been shown that cellulose-based fibers can be used as a fat substitute in food preparations. In this case, for example by replacing 50% by weight of an oil or fat with the cellulose-based fibers produced according to the invention, a similar preparation consistency/volume and equivalent or better sensory quality characteristics can be achieved compared to the preparations produced with otherwise usual amounts of fats or oils.

Furthermore, it has surprisingly been found that biogenic abrasive and non-abrasive scouring and cleaning agents can be produced by one of the methods according to the invention. It was found that lignin-containing cladding materials and in particular lignin-based shells were completely or partially solvated/unlocked by the process steps according to the invention. With increasing duration and intensity of the aqueous disintegration/unlocking process with solutions containing dissolved disintegration compounds, at least some small to very small particles whose surfaces exhibited increased roughness and at the same time increased amount of rounded outer contours with no sharp-edged particles were generated. Particularly preferred disintegration compounds are amino acids and/or peptides. By a partial and/or complete unlocking process of lignin-based shells, three-dimensional structures appear on the surface, which evidently have a very good absorption behavior for organic and inorganic particles and result in good solubilization properties of surfactants. When cleaning vessels, it was noted that the lignin-based shell fractions obtained with one of the aqueous disintegration/unlocking processes of the present invention, especially in combination with a surfactant, resulted in significantly better cleaning, especially in incrusted organic or inorganic buildup. In contrast to scouring agents from the prior art, there were no scratch marks when a glossy surface was cleaned of encrustations with the inventively disintegrated and unlocked lignin-based shell material. Thus, the methods of the invention are suitable for producing abrasive or non-abrasive biogenic scouring agents from lignin-based shell materials.

Preferred is a process for the preparation of abrasive and non-abrasive biogenic scouring agents.

Preferred is the use of lignin-containing shell material as an abrasive and non-abrasive biogenic scouring agent.

Surprisingly, a simple aqueous process to disintegrate plant cladding materials, which ensures a subsequent, technically simple complete separation of the cladding materials, but also allows a hydration of cladding materials, thereby enabling unlocking and recoverability of the solid constituents of the plant cladding material. Thus, pure fractions can be obtained from plant cladding materials that were previously unattainable or difficult to recover and were contaminated with other organic impurities. In addition, the disintegration/unlocking allows the preservation of basic components (constituents) of the unlocked cladding materials, which are of additional values when used as raw materials for further processes/products. Thus, the method can be used to produce fiber products from plant cladding material by a disintegration/separation and solving of the cladding material.

Preference is given to a process for producing fiber products obtainable by disintegration and/or separation and/or solving/unlocking of plant cladding materials by means of aqueous solutions containing dissolved compounds for disintegration/unlocking.

Thus, the object of the invention can be achieved by a process for the production of fiber products, obtainable by a disintegration and/or separation and/or solving of plant cladding materials by means of aqueous solutions.

### DETAILED DESCRIPTION

The cladding material of plant seeds or kernels changes structurally and functionally after completion of the growth phase. This includes, among others, a shrinkage and irreversible closure of the water-transporting capillary structures. Furthermore, there is a hornification of cellulose-based fibers. As a result, plant seeds, grains and kernels, which are enclosed by such cladding layers, do not or only swell after long exposure to water. Furthermore, this process results in formation of a mostly very robust layering, which protects the enclosed plant product very effectively against mechanical alteration. Surprisingly, aqueous solutions of dissolved amino acids and peptides are suitable for effecting disintegration of the compacted and hornificated plant cladding materials. It was further surprising that the processes for disintegration are also suitable for further dissolving/unlocking the disintegrated plant cladding material into its individual components, thereby obtaining pure fractions of solid matter, as well as dissolved soluble compounds present in aqueous solutions.

This effect was particularly pronounced when using cationic amino acids. Therefore, amino acids having one or more cationic charge groups or peptides containing amino acids having one or more cationic charge groups are particularly preferred. Preferred amino acids are arginine, lysine, histidine, as well as derivatives of these.

The peptides which can be used according to the invention may be di-, tri- and/or polypeptides. The peptides of the invention have at least one functional group that has bound or can bind a proton. The preferred molecular weight is less than 500 kDa, more preferably <250 kDa, more preferably <100 kDa, and most preferably <1,000 Da. The preferred functional groups are in particular a guanidine, amidine, amine, amide, ammonium, hydrazino, hydrazono, hydroxyimino or nitro group. The amino acids may have a single functional group or more of the same class of compounds or one or more functional group (s) of different classes of compounds. The amino acids and peptides according to the invention preferably have at least one positively charged group or have a positive total charge. Particularly preferred are peptides with cationic functional groups. Preferably, a pH of the cationic amino acid or peptide solution ranges from 7 to 14, more preferably between 8 and 13, and more preferably between 8.5 and 12.5. In one embodiment, the pH can be adjusted to any pH range between 6 and 14 by the addition of an acid or a base. Acids and bases known in the art may be used, such as caustic soda or HCl.

Particularly preferred peptides contain at least one of the amino acids arginine, lysine, histidine and glutamine in any number and sequential order. Particular preference is therefore given to amino acids and/or derivatives containing at least one guanidino and/or amidino group. The guanidino group is the chemical residue H2N—C(NH)—NH— and its cyclic forms, and the amidino group is the chemical residue H2N—C(NH)— and its cyclic forms. Preference is given to guanidino compounds which, in addition to the guanidino group, have at least one carboxylate group (—COOH). Further, it is preferable that the carboxylate group (s) be separated from the guanidino group in the molecule by at least one carbon atom. Also preferred are amidino compounds which have at least one carboxylate group (—COOH) in addition to the amidino group. It is further preferred if the carboxylate group (s) is separated from the amidino group in the molecule by at least one carbon atom.

Also suitable are di-, tri- or oligopeptides as well as polypeptides which are composed of one, two or more amino acids. Preference is given to short-chain peptides, e.g., RDG. Particularly preferred are peptides which consist of amino acids which have both hydrophobic and hydrophilic side groups, such as (letters according to amino acid nomenclature) GLK, QHM, KSF, ACG, HML, SPR, EHP or SFA. Further particularly preferred are peptides which have both hydrophobic and cationic and/or anionic side groups, such as RDG, BCAA, NCR, HIS, SPR, EHP or SFA. Further examples with 4 amino acids are NCQA, SIHC, DCGA, TSVR, HIMS or RNIF or with 5 amino acids are HHGQC, STYHK, DCQHR, HHKSS, TSSHH, NSRR. Particularly preferred are RDG, SKH or RRC.

The process is performed using aqueous disintegration solutions in which the amino acids and/or peptides according to the invention are completely dissolved. The concentration of the amino acids and/or peptides can in principle be chosen freely, preferred are concentrations of 10 μmol to 3 mol/l, more preferably between 1 mmol to 1 mol/l and more preferably between 100 μmol to 0.5 mol/l. The amino acids or peptides according to the invention can be present individually or in any combination in the aqueous solutions. The volume ratio of the aqueous phase containing the dissolved amino acids or peptides in relation to the plant products or cladding materials to be treated can in principle be chosen freely, but complete wetting of the cladding materials which are to be disintegrated/dissolved or unlocked should be ensured. It is preferred to completely immerse the plant materials to be treated into one of the solutions according to the invention. Furthermore, it has been found that the process of disintegrating plant cladding materials including peels can be accelerated by disintegration additives which are dissolved in the aqueous disintegration solutions. Such compounds include, but are not limited to, the following compounds, such as: urea, NH₃, triethylamine, diethylamine; ionic or nonionic surfactants such as SDS or DMSO; antioxidants or sulfates and sulfites, such as sodium sulfite or sodium bisulfite, further carbonates, such as sodium carbonate or sodium bicarbonate.

Preferably, the compounds are dissolved in water in a concentration of between 0.1 and 30% by weight, more preferably in a concentration of between 0.5 and 15% by weight, and most preferably between 1 and 5% by weight. The compounds can be used individually or in any combination. The process of disintegration of plant cladding material may be controlled via various parameter settings depending on the effect to be achieved. Thus, for example, in one embodiment, hydration of the cladding material and disintegration occur in the area of the germ, for example in soybeans. This is sufficient, for example, to perform a mechanical stripping of the entire cladding material by means of a squeezing device. For this purpose, for example, the immersion of the intact beans in an unlocking solution containing arginine 0.3 molar at 25° C. for 6 hours is sufficient. This can be tested by completely removing the cladding material by “pressing” with your fingers. In another application, walnuts that already had the outer shell removed were placed in a 0.2 molar lysine solution at 35° C. for 3 hours. After draining the solution, it was possible to completely detach the seed coat by means of a water jet device, wherein the resulting seed coats remained largely complete and intact. The walnuts obtained had >98% removal of the seed coat. All shells/skins obtained from the unlocking/disintegration processes were soft and flexible. In another embodiment, chopped almonds were placed in a 100 mmol histidine solution for 20 minutes at 20° C. Subsequently, they were separated from the solution and the detached seed coats were removed in a hydrocyclone. It was possible to achieve >95% removal of the seed coats. In another embodiment, the seed coats of kidney beans were removed. For this purpose, the beans were placed in an autoclave in a solution of polylysine and histidine and treated at a temperature of 120° C. and a pressure of 1.2 bar for 3 minutes. Then the shell layers were easily and completely detachable with 2 fingers.

In preferred process embodiments, the process of disintegrating plant cladding materials may be used to hydrate cladding/shell/skin layers and/or to disrupt the texture of seed coats and skins at preformed sites and/or to dissolve intermediate layers of cladding materials and/or soften cladding layers and skins. According to the different requirements and differences in the starting materials, the concrete conditions in a process must first be determined. In general, however, the following parameter settings are preferred: The duration of exposure of the plant material to the aqueous disintegration solutions according to the invention is in principle freely selectable. Preferably, an exposure time is between 5 minutes and 48 hours, more preferably between 10 minutes and 24 hours, and more preferably between 15 minutes and 12 hours. A sufficient exposure time can be easily detected by testing the treated plant products as to whether the effect to be achieved, such as the peelability of a seed coat or cladding layer, is achieved. The temperature at which the exposure of the plant material to the aqueous disintegration solutions containing dissolved amino acids and/or peptides and/or other dissolved compounds for disintegration takes place can in principle be chosen freely. Preferable, however, is a temperature range between 5° and 145° C., more preferred is a temperature range between 10° and 140° C. and most preferably between 15° and 80° C. The exposure is preferably carried out under normal pressure conditions. In a preferred embodiment, a lower or higher pressure can be applied to the reaction mixture, the preferred pressure is between 0.1 bar and 10 bar, more preferably between 0.5 bar and 5 bar and more preferably between 0.8 bar and 3 bar. A simultaneous increase in temperature and pressure during the exposure of the plant material to be treated with aqueous solutions according to the invention for disintegration is preferred. Preference is given to carrying out the exposure of the plant material with the aqueous disintegration solutions according to the invention in an autoclave. The preferred treatment time in an autoclave is between 30 seconds and 60 minutes, more preferably between 1 minute and 30 minutes and more preferably between 2 minutes and 15 minutes.

In a preferred embodiment, the hydrated and partially or completely disintegrated cladding materials are fed to a device which permits removal of the cladding material. A large number of such devices are available in the prior art. Preference is given to product-sparing embodiments, since in this way the advantageous effects of the product-sparing treatment according to the invention can be implemented for the separation of the plant cladding material. For example, hydrodynamic methods are suitable in which shear forces are applied to the cladding material by means of a water jet, leading to their separation. But also mechanical processes can be very advantageous. In a particularly preferred embodiment, the pretreated seeds, grains or kernels are sorted by size and delivered to a blow-out device. Here, upon entry into a flexible or rigid tube/sleeve or only during the transport route herein, tearing of the disintegrated cladding material and translocation/separation of the cladding material from the seed, grain or kernel takes place. Upon exit from the tube/sleeve, which may be under pressure application, the seeds, grains or kernels are spatially separated from the cladding material by various applicable methods, such as using gravity or air sifting. The suitability of a disintegrated plant starting material to carry out a separation and removal of the cladding material can be determined, for example, by a stripability of the disintegrated cladding material by a light rubbing between the palms is possible.

In a preferred embodiment, a disintegration of plant cladding materials according to the invention is carried out following a mechanical disintegration process. Preference is given to coarsely ground seeds, gains or kernels in which de-oiling has taken place and/or a separation of other valuable substance fractions, such as, for example, proteins and/or carbohydrates, is to take place. It has been shown that even such coarse- to fine-grained plant products can be purified with the disintegration solutions from cladding components according to the invention. For their separation, cyclone separation techniques or sieving methods can also be used.

In one embodiment, the hydration and removability of the plant cladding material by aqueous disintegration solutions containing dissolved amino acids and/or peptides and/or other dissolved compounds for disintegration is increased by the addition of surfactants and/or digesting agents.

In one embodiment, the aqueous solutions may contain disintegration additives or auxiliaries, e.g. alcohols or surfactants. Preferred alcohols are methanol, ethanol. Preferred surfactants are urea, thiourea, sodium lauryl sulfate and DMSO. Preferred disintegrating agents are sodium bisulfite and sodium sulfite. The concentration required for each application must be determined individually.

Preferably, separation/detachment of the cladding-/shell materials is performed immediately after exposure of the plant products to one of the aqueous disintegration solutions of the invention. A separation/detachment can also be done at a later point in time. It has been shown that if a disintegration or dissolution of the cladding material is carried out with one of the methods according to the invention, cladding materials that have dried in the meantime can also be separated/removed very easily by dissolution/swelling in water. Therefore, the inventive method can also be used for the preparation of plant products for easier separation of the cladding material at a later point in time. It has been found that the cladding material hereby pretreated becomes already partially or completely odorless and/or tasteless. In one embodiment, a method according to the invention is therefore also used for flavor neutralization/debittering of cladding materials with or without simultaneous disintegration/detachment of products of the cladding materials. The duration of the required exposure and the temperature and pressure conditions must be determined individually.

In a further preferred embodiment of the method, cladding materials that have been disintegrated and separated from plant-based starting materials and/or cladding materials mechanically separated from the plant starting material are placed into one or several disintegration solutions, or consecutively, containing dissolved amino acids and/or peptides and/or other compounds for disintegration. Advantageously, a disintegration process is hereby continued or initiated, wherein the cladding material is completely wetted. As a result, for example, a softening of previously brittle and easily breakable cladding materials can be produced, whereby these disintegrated cladding materials have a very high flexibility and no longer break. The preferred form of disintegration for this purpose is carried out by long-term submersion into one of the aqueous solutions according to the invention. Preferred is a duration between 15 minutes and 30 days, more preferably between 60 minutes and 14 days and more preferably between 10 hours and 7 days. The concentrations of the dissolved amino acids and/or peptides should be chosen accordingly; for orientation, the values given above may be used. Preferably, the disintegration is carried out at room temperature. The pH is preferably adjusted between 6.5 and 13, more preferably between 7 and 12 and more preferably between 8 and 12.5. In a further preferred embodiment, the conditioning/softening of plant cladding material is carried out by a short-term treatment in an autoclave. It has been found that the softening of the separated cladding material can also take place at elevated temperature and elevated pressure with a short exposure time. Preferred is a temperature range between 80° to 140° C., more preferably between 90° and 130° C. and more preferably between 100° and 121° C. The preferred pressure is between 0.5 to 10 bar, more preferably between 0.8 and 5 bar and more preferably between 1.0 and 2 bar.

The exposure time is preferably between 20 seconds and 10 minutes, more preferably between 30 seconds and 8 minutes and more preferably between 40 seconds and 3 minutes. It is preferred to subject the cladding materials that have been disintegrated and softened according to the mentioned method variants, to an extensive rinsing in water. Such disintegrated cladding materials do not dissolve further when left in neutral water. Here they can be stored for a long period, which can be longer than 6 months, in an unchanged condition. But they can also be dried and stored. The production of a composite/texture from the individual cladding material constituents is preferred. This is advantageously done by pressing the cladding materials, e.g. on a filter press device, whereby, for example, molded plates/sheets can be produced. This compacted material can be dried, for example, in a drying cabinet. The obtainable compressed cladding material panels are characterized by their enormous swellability when placed in water, which is preferably >200% by weight, more preferably >300% by weight, and more preferably >400% by weight. Preferably, during the processing to obtain the disintegrated moldable cladding materials, in one or more additional or simultaneously occurring processes, a conditioning and/or functionalization of the disintegrated cladding material can also be achieved with one of the methods described above or below. Advantageously, also and in particular with this method disintegrated softened/flexible plant cladding materials were prepared which are completely or almost completely odorless and/or tasteless. Almost completely means >98%. In other words, a more than 98% reduction of the previously present odorants and/or flavorings has taken place. Further, disintegrated and softened cladding materials do not release any or almost no colorants in an aqueous medium. In one application, it was shown that the garlic cladding material could be formed into a taste-neutral, highly flexible plates/sheets.

Furthermore, additives can be added to the aqueous disintegration solutions according to the invention containing dissolved amino acids and/or peptides, whereby further particularly advantageous effects are achieved, which condition or promote, for example, conditioning and/or functionalization and/or enhancement of the disintegration of the plant cladding material. In one embodiment, carboxylic acids are completely dissolved in the aqueous solutions containing cationic amino acids and/or peptides. This is particularly advantageous because carboxylic acids can be brought to complete dissolution by the cationic compounds in an aqueous medium to form nano-emulsions. This makes it possible in a particularly advantageous manner to shorten the exposure time until detachment of plant cladding material is achieved, in many applications. Furthermore, the cladding materials can be loaded with the dissolved carboxylic acids during the hydration process initiated by the aqueous solutions according to the invention or advantageously incorporated and/or applied in the hydrogenated cellulose-based fibers. This makes it possible, on the one hand, to produce cladding materials with modified surface properties which, for example, have hydrophobic properties or anti-microbial functionality. On the other hand, in the case of disintegration/solvation of the cladding materials, cellulose-based fibers can be produced that are loaded with carboxylic acids, such as, for example, omega-3 fatty acids.

Preferred carboxylic acids which are dissolved in the aqueous solutions according to the invention are fatty acids, such as, for example, monounsaturated or polyunsaturated fatty acids, such as oleic acid or linolenic acid, and also organic acids, such as acetic acid or ascorbic acid. The preferred concentration of the carboxylic acids may be between 1 μmol and 3 mol/l, more preferably between 1 mmol to 1 mol/l and more preferably between 100 μmol and 0.5 mol/l. Preferably, the carboxylic acids are completely dissolved in the aqueous disintegration solutions according to the invention. The total amount of carboxylic acids is therefore limited to the number and concentration of the cationic compounds that are in the mixed solution and allow a solution of the carboxylic acids.

Further compounds can also be added to the aqueous disintegration solutions. In a preferred embodiment, ionic or nonionic surfactants are added as additives. This is particularly advantageous in the recovery of cellulose-based fibers from cladding materials, which have a significant proportion of fats or waxes. Further preferred is the use of urea or creatine as an additive. In one embodiment, additives are used to achieve a better/more complete unlocking of the cellulose-based fibers from the organic matrix.

In a further embodiment of the method, apart from disintegration, there is also an unlocking and a separation of the components (constituents) of the plant cladding material.

In a preferred method embodiment, disruption/dissolution of lignin and/or lignin-containing polymer structures and of hornified cellulose-based fibers by a combination of compounds for disintegration in the form of an aqueous solution or a sequence of aqueous solutions with one or more disintegration additive (s). Particularly preferred are sodium sulfite, sodium bisulfite, urea, thiourea, sodium lauryl sulfate and DMSO and carbonates, such as sodium bicarbonate. The concentration of the disintegration additives in an aqueous solution in which they are preferably in dissolved form is preferably between 50 μmol and 3 mol/l, more preferably between 1 mmol and 2 mol/l and more preferably between 200 mmol and 1 mol/l. The compounds or aqueous solutions can be used together with the dissolved amino acids and/or peptides according to the invention or in sequential order. Preferred is an unlocking process in which the dissolved amino acids and/or peptides are used together with the additives. The preferred temperature at which unlocking of lignin and/or lignin-containing polymer structures occurs is preferably between 40° and 140° C., more preferably between 60° and 130° C. and more preferably between 80° and 120° C. Preference is given to the simultaneous application of pressure to the reaction mixture. Preference is given to an overpressure from 0.5 to 10 bar, more preferably from 0.8 to 8 bar and more preferably from 1 to 6 bar. The exposure time of the starting material with the aqueous solutions must be determined individually, since the degree of crosslinking of the lignin polymers and the degree of hornification of the cellulose-based fibers in the starting materials can vary greatly. The exposure time needed can be very easily determined by taking samples from the reaction vessel. A sufficient exposure time is in particular present when dark brown to black structures of the plant cladding materials do not exist or exist only to a small extent or have disintegrated into very small particles. Furthermore, the exposure time is sufficient if, in a microscopic analysis, no coherent fiber structures can be detected.

It has been found that lignin-based cladding material is disintegrated by use of the methods of the invention and can be recovered in the form of, for example, an intact cladding/shell material or shell fragments. Lignin-containing shell materials are found, for example, in seeds or grains of jatropha, rape oilseed, sunflowers or seeds of apples and pears. The plant cladding material may in this case be present in an intact or partially or completely mechanically or thermally disintegrated state, for example after extraction of an oil fraction or in the form of a pomace after juicing. The processes of the invention serve to obtain recoverable valuable material fractions.

In another process embodiment, the press residues of plant seeds, such as the press cake of rapeseed or jatropha, which were obtained among others from an aqueous unlocking process, were subjected to the inventive solutions by being soaked until saturation herewith. Such soaked material is completely soaked, but not wet. After 4 hours, dispensing of the solid constituents in water was achieved with a mixer. The solid components were separated by means of a filter and fed to a further process stage with the aqueous unlocking mixtures. In one embodiment, for example, a solution of 0.2 molar lysine and 10% by weight of urea can be used, in which the solid filter residue is placed for 6 hours. Subsequently, the liquid phase is removed by a chamber filter press and the filter residue is dispensed in water and then separated by means of a hydrocyclone resulting in 2 solid fractions: cellulose-based fibers and lignin-based shell particles. It could be shown that a separation of the constituents from the fiber constituents with the methods for the disintegration and detachment of lignin-based constituents is possible and a separation of the different fiber constituents can be achieved, and this is why lignin-based shell fractions can be obtained as a separable valuable material fraction on a large scale.

The obtainable cellulose-based fibers have a varying degree of hornification, depending on the source of the starting material and the disintegration/unlocking process chosen, or by the chosen dewatering process or by the exposure to a bleaching agent. This results in crystalline areas that lead to a clearly perceptible graininess in the mouth and cause a small-grained particulate feeling while chewing, which is undesirable. Surprisingly, it has been found that in a disintegration/unlocking process in which the amino acids and/or peptides according to the invention have been used, virtually no hornification of cellulose-based fibers occurs. Furthermore, it has been found that if hornification of the cellulose-based fibers exists, the degree of hornification can be significantly reduced or the hornification can be completely reversed by disintegration with a solution containing amino acids and/or peptides according to the invention. It could thus be shown that in beet pulp, which had been disintegrated with a sodium sulfite solution at 130° C. and an excess pressure of 1.2 bar for 10 minutes, the mass obtained after homogenization and separation of the free liquid consisted of cellulose-based fibers which had a high degree of hornification and were therefore not edible. When this mass was inserted into a 0.3 molar arginine solution it came to an unlocking of hornification while mixing, so that practically no graininess existed after 3 hours.

Preference is given to a process for the disintegration/unlocking of hornification of cellulose-based fibers.

In a preferred process embodiment, the lignin-based shells or shell fragments that are obtained from a previous disintegration process according to one of the processes described herein or from another process are subjected to an unlocking process with one of the unlocking solutions. It is preferable herewith to achieve a dissolution and/or unlocking of the lignin polymer structures. Of course, the complexity of these structures in the various cladding materials is different, so that the exact reaction conditions must be adjusted individually. It is preferred to disintegrate and unlock the lignin-based cladding materials/shells or fragments thereof in a solution of sodium sulfite, preferably together with a dissolved amino acids and/or peptides and/or urea and/or carbonates, at elevated temperature and preferably under elevated pressure. Preferred are concentrations of sodium sulfite or sodium bisulfite, but also of sodium carbonate or sodium bicarbonate of from 0.1 to 3 molar, more preferably from 0.3 to 2 molar. Preferred concentrations of dissolved amino acids and/or peptides (singly or together) are 0.1 to 3 molar, or up to the solubility limit, more preferably from 0.2 to 2 molar. Preferably, a pH of the disintegration solution is between 8 and 14, more preferably between 8.5 and 13 and more preferably between 9 and 12.5. The preferred temperature is between 60° and 180° C., more preferably between 70° and 160° C. and more preferably between 80° and 140° C. The preferred pressure increase is 0.1 to 20 bar, more preferably 0.2 to 10 bar. The duration of the disintegration depends on the process parameters and the starting material. Preferably, duration of disintegration is between 10 minutes and 24 hours, more preferably between 15 minutes and 10 hours and more preferably between 15 minutes and 6 hours. Preferably, the disintegrated and/or partly dissolved and/or dissolved cladding material or shells or fragments thereof are subjected to an extensive rinse with water or a suitable surfactant mixture. If no turbidity shows up in the rinsing solution, the flushing process is complete. The resulting fraction of lignin-based shells is preferably subjected to a drying process. In a preferred method embodiment, the separation of unbound water is accomplished by means of a sieving device or by means of a centrifugal process. Preference is given to vibrating screen devices and centrifuges. The lignin-based shell material is usually then free-flowing already and can then be dried to a residual moisture of preferably <20% by weight, more preferably <15% by weight and more preferably <10% by weight, e.g. in a belt dryer or vacuum drying oven. It is stored dry until it is used.

Since the disintegration process also detaches/liberates cellulose-based fibers, in a preferred process embodiment the proportion of cellulose-based fibers is separated before, during or after further processing. This can preferably be done by means of known processing techniques.

Cyclone separation processes in which a semiselective discharge of particles of different density and with different settling behavior takes place are preferred. Preference is given to the use of a hydrocyclone. The purity of the fraction of lignin-based shell particles obtained can be determined, for example, in a microscopic analysis. Preference is given to a purity of the obtainable fractions of >90%, more preferably of >95% and more preferably of >98.5%. On the other hand, the residue of cellulose-based fibers in the lignin-based shell fraction is generally not perturbing. It could be shown that in the presence of >5% cellulose-based fibers in the fraction of lignin-based shell particles a scratchability of scratch-sensitive surfaces, which can be caused by a high contact pressure of abrasives, is reduced.

In a preferred embodiment, size selection and/or size reduction of the lignin-based shell portions to a defined extent/size can occur at any point in the process. This is preferably done at the end of the process. Preferably, a size sorting is carried out by means of retention by screening/filtering devices. This can be done with both dried, as well as in water suspended lignin-based shell particles. Comminution can also be performed on dried or soaked lignin-based shell particles. For example, cutting or grinding mills are suitable. The obtainable size distribution can be determined by available analysis sieve/filtering devices.

Depending on the plant-based starting material, the intensity of the disintegration process and a fragmentation of the cladding material, two-dimensional or three-dimensional particles of lignin-based shell constituents are formed. In the chemical analysis, a lignin content of >40% by weight was determined. Preference is given to obtaining corpuscular (three-dimensional) particles having a lignin content of >40% by weight, more preferably of >50% by weight, more preferably of >60% by weight, even more preferably of >75% by weight and particularly preferably of >90% by weight. The composition can be determined by analytical methods.

Preference is given to a process in which corpuscular particles/shell fragments having a lignin content of >40% by weight are obtained by disintegration of a plant starting material.

It has been found that these lignin-based shell fragments have abrasive properties or scrubbing properties regarding organic or inorganic encrustations on different surfaces. Surprisingly, different abrasive properties of lignin-based shell components resulting from the processes could be found. It has been shown that when scratch-sensitive surfaces, such as a gloss varnish or a glossy plastic surface, were treated with a mechanically comminuted lignin-based shell material, obtained from one of the disintegration procedures of cladding materials, using a constant pressure for the removal of encrustations, scratching or furrowing at the site of removal of the adhesions could be observed. In contrast, there were no furrows/scratches of the surfaces when using plant cladding material obtained from a disintegration process according to the invention, by using otherwise identical cleaning/detachment conditions for the removal of firmly adhering contaminants and with the use of an identically selected contact pressure.

Thus, the disintegration of the lignin-rich shells results in a different abrasive property that can remove surface contaminants and, in particular, encrustations, such as organic materials such as proteins, without causing discrete erosions (scratches/furrows) on surfaces that can be easily scratched (scratch-sensitive) surfaces, as is the case with high-gloss plastic surfaces or glossy varnishes.

Abrasive here refers to a removal of adhesions, caking or encrustations that are present on a material surface, such as metals, ceramics, glass, plastics, paints or biological materials, such as leather. Abrasive in this context does not mean that there is injury/damage to the surfaces/surface integrity of the abrasive-treated materials/material surfaces. Microscopically, micro- and/or nano-surface irregularities of the surfaces were discernible with lignin-based shells/shells fragments made by one of the process steps were visible, but the outer contours were sharp-edged and/or pointed. These lignin-rich shell fragments had very good abrasive properties on encrustations on metals, glass or ceramics, which could be significantly more easily removed compared to abrasives from the prior art. Scratch marks were not recognizable here, which was the case when cleaning of painted and plastic surfaces with such lignin-rich shell fragments. Surprisingly, it was found that by further disintegrating of the lignin-based shell fractions according to the methods described herein, the particles became more rounded and had flat-arched outer contours but still had abrasive effects on encrusted residues on surfaces. With these rounded lignin-based shell fraction, there were no scratches when suspended in a soap solution and used to polish a high gloss lacquer or high gloss plastic surface using a downforce of 0.2N. Common to both forms of lignin-based shell fractions, however, is a high removal/release property on encrustations. Furthermore, both forms exhibit micro and/or nano surface roughness. The preferred lignin-based shell fractions which can be used for an abrasive, scratch-free application can have any shape. Preferably, they are disk-shaped particles. But other spatial structures may be present. In a preferred embodiment, the particles preferably have an average particle size between 100 μm and 3 mm, more preferably between 200 μm and 1 mm and even more preferably between 300 μm and 800 μm. In one embodiment, the size is sorted by a sieving device. Agitatable sieves, such as vibrating sieves or air classification devices, are preferred.

Preference is given to the production of abrasive particles from plant starting material for lifting off/detachment of surface encrustations.

Preference is given to the production of abrasive particles from lignin-based shells for lifting off/detachment of surface encrustations.

In one embodiment, therefore, a disintegration of the lignin-based shell is preferred in which particles to preferably 95 weight %, more preferably >97 weight %, more preferably >99 weight % and more preferably until all lignin-based shell particles are present in a well-rounded shape. With this quality feature, a non-scratching abrasive scouring agent is available with which easily scratchable surfaces, e.g. of paints and plastics, can be cleaned. Preferably, a formulation of the non-scratch-generating abrasive scouring agent according to the invention is carried out by adding the lignin-based shell fraction prepared according to the invention to a surfactant/soap solution and suspending it in this solution. The lignin-based shell fractions can be added to the surfactant/soap solution in still moist or dried form and preferably by means of a high-speed shear mixer.

For use as a scouring agent, the lignin-based shell portions may be used in the wet, dried or powdered state. Particularly suitable for the production of abrasive scouring agents from lignin-based shell fractions are the shell components of jatropha and rapeseed grains/seeds.

In a preferred embodiment, the disintegration/disruption of the plant cladding material according to the invention takes place together or in immediate succession with a disintegration/unlocking of the plant seeds, kernels or grains. This is particularly advantageous since this can be done with the same aqueous disintegration/unlocking solutions. For this, it is usually necessary to choose a longer exposure time and/or process parameters other than those for the disintegration/detachment/dissolution of cladding materials. In particular, an extension of the exposure time may be required, preferably an exposure time of between 10 minutes and 48 hours, more preferably between 30 minutes and 24 hours and more preferably between 1 hour and 12 hours.

Furthermore, it is preferred to increase the temperature of the reaction mixture during the exposure with the aqueous solutions according to the invention, preference is given to temperatures between 20° and 140° C., more preferably between 30° and 120° C. and more preferably between 40° and 80° C. In a particularly preferred embodiment, following disintegration of the whole plant starting material, unlocking of the constituents of the starting material is achieved, in which the soluble components, such as proteins and soluble carbohydrates are completely dissolved in an aqueous dispensing volume and the solid constituents, such as cellulose-based fibers and lignin-rich shells are suspended in the aqueous dispensing phase. Preferably, a water volume is chosen here, which ensures easy separability of the solid constituents. Preferably, the added water volume ratio to the process mixture resulting from the disintegration process is from 2:1 to 200:1, more preferably from 5:1 to 100:1, and even more preferably from 10:1 to 50:1. The temperature at which this process step can take place is arbitrary; a temperature range between 5° and 95° C. is preferred. The dispensing volume is preferably admixed by means of an intensive mixing feed, preferred are high-performance shear mixers/dispersers or homogenizers. The presence of a sufficient dispensing volume or degree of disintegration or unlocking of the constituents of the starting material can be detected by removing a sample from the suspended mixture and filtering it. If, for example, in a microscopic analysis the filterable solid constituents have no adhesions of soluble constituents, the process is complete. Preferably a subsequent separation of the suspended solid matter, preferably by filtration or a centrifugal separation process is performed. Preferred is the separation of dissolved constituents present in the aqueous dispensing volume after separation of the solid constituents, of which preferably <5 wt %, more preferably <2.5 wt % and more preferably <1 wt % are present in the separated aqueous dispensing volume.

Preference is given to a separation of dissolved proteins which is achieved by adding other soluble constituents to the aqueous dispensing volume containing dissolved proteins and optionally other soluble constituents of the starting material for the initiation of aggregation/complexation. These are preferably one or more organic acids, preference is given to carboxylic acids, such as, for example, citric acid or lactic acid or ascorbic acid. But other acids can be used, such as HCl or phosphoric acid. Furthermore, combinations of different acids are possible. The pH of the aqueous solution containing dissolved compounds for aggregation/complexation, in which the condensation and/or aggregation and/or complexing of the dissolved proteins and/or other dissolved compounds takes place according to the invention is preferably in a range between 4.5 and 13, more preferably between 6 and 12, and more preferably between 6.5 and 11. Further, enhancers of complex formation can be added before/during and/or after acid addition, such as calcium and/or magnesium compounds such as calcium chloride or magnesium chloride. Furthermore, the salinity of the aqueous dispensing volume can be varied. The individual dosage depends on the concentration of dissolved and aggregatable compounds and must therefore be determined in each case. It has been found that a sufficient dosage is used, for example, when well-visible aggregates have formed, while the previously turbid aqueous dispensing phase simultaneously clarifies. However, analytical methods can also be used: after an aggregation of proteins according to the invention, and after their separation, preferably <than 5% by weight, more preferably <than 2.5% by weight and more preferably <1% by weight of dissolved proteins remain in the process fluid.

The aggregating/complexing agent (s) added is/are mixed in a preferred process with an agitator and with little agitation of the process liquid. It is important to ensure thorough mixing. The duration of the mixture is in principle freely selectable. In a preferred method embodiment, this takes place only over the duration of the addition of one or more aggregation/condensation agent (s) or for a duration of between 10 seconds and 5 minutes, more preferably between 20 seconds and 2 minutes. In a particularly preferred embodiment, therefore, following the addition of one or more aggregating/condensing agents, a residence time is maintained in which no or only minimal mixing of the mixture takes place. In an analogous manner, the required time of the condensation phase can be determined, preferably it is between 5 minutes and 10 hours, more preferably between 10 minutes and 5 hours and more preferably between 15 minutes and 2 hours. If the residence time is to be reduced to a minimum, the sufficient minimum duration of residence time after addition of the complexing/aggregating agent may be determined by centrifugation of a sample by which the completeness of condensation and/or aggregation and/or complexation that has been provided by the/the complexing/aggregating agent is checked by adding the same and/or another solution with an aggregating agent to the supernatant of the centrifugate. Unless further aggregation occurs, the extraction process of dissolved proteins is complete. In a preferred method embodiment, aggregation/complexing of the dissolved proteins results in sedimentation of the aggregates/complexes. Preferably, these aggregates/complexes condense in the further course, so that they can be easily separated from the free water phase of the process medium.

In a preferred method embodiment, the aggregated/complexed and condensed compounds/proteins are made recoverable in the form of a sediment phase (condensation phase). The drainage of the sediment phase preferably is accomplished via a bottom outlet and is fed to a further process sequence. This condensation phase is preferably carried out at ambient temperatures, preferably at a temperature ranging between 15° and 40° C. In further advantageous embodiments, this is performed at a lowered or elevated temperature. Preference is given to a temperature ranging from 5° to 15° C. on the one hand and from 40° to 80° C. on the other. The selection of a lowered temperature may be advantageous, for example, in the recovery of thermolabile compounds. The choice of a high temperature, e.g. 60° C., may be chosen, for example, to kill germs, e.g. in the form of a pasteurization process, in the event of microbial contamination of the starting material. On the other hand, heating can also inactivate allergens and certain toxins and anti-nutritive compounds.

Preferred is a method for obtaining a protein-containing sediment consisting of aggregated/complexed and condensed proteins.

Preference is given to a method for producing and obtaining proteins from plant starting materials, obtainable by disintegration/disruption with separation of disrupted dissolved proteins and subsequent aggregation/complexation and condensation.

The obtainable protein mass can be used directly or be forwarded to further purification steps.

In studies on the isolation of dissolved proteins from aqueous solutions with other dissolved soluble constituents obtained by the separation/dissolution process in the aqueous solution containing dissolved disintegration/unlocking compounds, it has been found that by the hydration of the proteins that is achievable by the process, and by selection of suitable process parameters, a very pure protein fraction can be obtained. Pure means that the protein fractions have a protein content of preferably >60% by weight, more preferably >70% by weight, more preferably >80% by weight and still more preferably >85% by weight and most preferably >90% by weight.

It has been found that such pure protein fractions can be produced in particular by using a large dispensing volume after unlocking of the constituents according to the invention. Such dissolved proteins, for example, pass through a membrane filter with a pore permeability of at least 1 μm. This allows a size-selective separation of dissolved proteins.

Furthermore, it has been found in this particular situation where an optimal hydration of the dissolved proteins and a physiological pH range are present that, there is a very rapid and pronounced interaction with the complexing/aggregating agents listed herein, which results in an association of the hydrated proteins, causing displacement or exclusion of process water. This can be recognized, for example, by the formation of three-dimensional structures that are visible to the naked eye, which sediments only very slowly after their formation, while there is partial or complete clarification of the process fluid. The process fluid is then moderately to intensely colored and contains odors and flavors as well as soluble carbohydrates. Thus, the process of hydration and subsequent condensation of soluble proteins requires that the compounds previously released from the proteins remain in a dissolved state in the process water phase and do not combine with the condensing proteins or become discharged with the condensed proteins.

Preference is given to a method for producing protein condensates and/or protein concentrates and/or protein isolates from organic starting material by means of aqueous solutions containing dissolved disintegration/unlocking compounds.

In a further preferred embodiment, the disintegration/detachment/dissolution of the plant cladding material and/or the remaining constituents of the starting material of seeds, grains or kernels, which have already been thermally and/or mechanically disintegrated/divided/crushed. This shortens the required exposure time for the aqueous solutions according to the invention.

For the detachment and separation of the disintegrated/partly dissolved/detached cladding materials, preference is given to mechanical processes which exert shear forces on the treated cladding materials. In a preferred embodiment, the detachment and separation is accomplished by rollers, on which or between which the pretreated seeds/kernels are transported and at the same time undergo tangential shear forces. In particular, simultaneous separation using a flushing device or a fan device to separate the detached cladding materials is preferred.

In one embodiment, disintegration/dissolution or detachment of an intermediate layer, which is located on the plant seeds or kernels and/or on the separated cladding material is achieved using a longer residence/exposure time in/with one of the aqueous liquids according to the invention than is required for the disintegration/detachment/separation of plant cladding materials. Preferably, the exposure time is between 1 minute and 72 hours, more preferably between 10 minutes and 48 hours and more preferably between 30 minutes and 24 hours. The temperature of the reaction mixture can be chosen arbitrarily, preferred is a temperature in the range between 5° and 120° C., more preferably between 10° and 100° C. and more preferably between 15° and 70° C. The application of physical shear forces to the material to be removed from an intermediate layer is preferred. These shearing forces are preferably carried out in the reaction mixture, for example by rotation of the container or an agitator. Preferably shearing forces can also be produced by a rinsing/spraying device. Sufficient exposure time and application of shear forces to rinse off the intermediate layer can readily be determined by one skilled in the art by examining the treated product for its physical surface properties, such as the presence of a coating or skin formation, during drying.

In one embodiment, the plant cladding materials are disintegrated/partly dissolved or unlocked without removing them from the plant product. It has been shown that coating materials which have been at least dissolved or swollen by exposure to the aqueous solutions according to the invention no longer have to be removed from the plant seed or grain, since they no longer interfere during the further use of the seed or grain. In a further embodiment, the detached and separated plant cladding materials are disintegrated/partly dissolved/unlocked by one of the methods according to the invention. This is of particular interest when it is intended to extract and recover materials for further utilization which are contained in the plant cladding material, or to allow cellulose-based fibers to be produced and recovered. The concentrations of the cationic amino acids and/or peptides, as well as the exposure time and temperature and pressure of the reaction mixture (s) must be determined depending on the application.

### Cellulose-Based Fibers and Lignin-Rich Shell Fractions.

The nature and composition of cladding materials naturally varies from species to type of plant-based staring material. For the production of flours, the cladding materials, such as husks and seed coats are usually separated before grinding, since these are usually not desirable in the final products. This usually succeeds only with great process engineering effort and loss of grain/seed material as a result of mechanical particularization/fragmentation. Fibers, which are present in seeds, kernels and grains, but also in other plant-based starting materials as structural components, can not be separated or isolated without residues with prior state of the art methods, since they are completely/all-over bonded and compacted with the other constituents. In particular, a mechanical separation of these fibers is not possible in the prior art.

It was therefore quite surprising that both the lignin-rich shell particles as well as the cellulose-based fibers of the plant-based starting materials can be separated and decompacted and can be obtained in a directly pure form by the methods described herein. Thus, following a disintegration/unlocking process, after extensive removal of the bound water content from the solid matter fraction, no or nearly no proteins, soluble carbohydrates, odorants, flavors, or other organic or inorganic dissolvable compounds could be detected. Microscopically, the attachment of other organic components was evident.

The lignin-rich shell fractions exhibit a lignin content of 30-95% by weight. They are present as submillimeter-sized discs or have an amorphous form. After drying, they are free-flowing and pourable. There is a significant water retention capacity that can be >40%. The cellulose-based fibers microscopically have a cotton wool-like 3-dimensional structure with average diameters between 50 μm and 500 μm with an aspect ratio (length/diameter) of 1:1 to 1000:1. These are isolated/discrete structures that do not cohere and have a very low weight to length ratio of preferably <70 mg/100 m, more preferably <50 mg/100 m, more preferably <30 mg/100 m, further preferably <20 mg/100 m, further preferably <15 have mg/100 m and more preferably <10 mg/100 m. Such cellulose-based fibers have been found to differ significantly from cellulose fibers made, for example, from stems or wood, in chemical composition, secondary and tertiary structure, and physicochemical properties. Furthermore, it was found that both the recoverable cellulose-based fibers and the lignin-rich shell fractions had a significant water binding capacity which is more than 200 vol %. In addition, it has been found that both the lignin-rich shell fractions and the cellulose-based fibers are free or nearly free of odor or flavorants or colorants that dissolve in an aqueous medium. Therefore, the lignin-rich shell fractions and cellulose-based fibers obtainable by the process are already in a form in which they can be used or they can by dried by techniques of the prior art or they can be used for further processing.

Preference is given to a process in which pure lignin-based shell fractions and/or cellulose-based fibers are obtained from a plant-based starting material having a water binding capacity of >200 vol %.

Surprisingly, dried lignin-based shell fractions in addition to a high water-binding capacity and high water retention capacity also have an extremely large binding capacity for oils and fats. In experiments with various lignin-based shell fragments this was between 250% and 550% by weight. Noteworthy was that there are hydrophobic interactions between the surfaces and the oils, which led to a very rapid transport of the oils and fats along the outer surfaces of a granulate. As a result, oils and fats can be transported against a pressure gradient (gravity) by lignin-based granulate when present in a loose bulk via capillary forces of their inner and outer surfaces. In investigations using rising pipes filled with the material the static head exceeded 5 cm. Furthermore, it could be shown that the dried and powdered cellulose-based fibers also had a very high binding capacity for oils and fats, which was between 220 and 360% by weight.

Preference is given to a process in which pure lignin-based shell fractions and/or cellulose-based fibers are obtained from a plant-based starting material having an oil and/or fat binding capacity of >200% by weight.

Lignin-rich cladding fractions and/or cellulose-based fibers, having an oil and/or fat binding capacity of >200% by weight, obtainable by a process for disintegration and unlocking of plan-based starting material.

Surprisingly, it has been found that the obtained lignin-rich shell fractions and the cellulose-based fibers, found as a filter residue in the many of the plant-based products investigated, such as rapeseed and jatropha press residues, are very easily separated from one another by techniques known in the art.

Preference is given to cyclone separation technique, such as hydrocyclones, but filter techniques can also be used. It has been shown that this makes it possible to obtain pure fractions of cellulose-based fibers on the one hand and lignin-rich shell fractions on the other hand, in which no or almost no proteins, soluble carbohydrates, odors or flavors, or other organic or inorganic detachable compounds are present or which contain colorants which dissolve into an aqueous medium. The resulting shell or fiber fractions are preferably freed from water that is still bound by a pressing process. Alternatively, centrifugal processes can be used. The dewatered shell or fiber fractions can be used in the hydrated condition as obtained from the process or after they are completely dried. Drying processes are known in the art. A drying process using hot air is preferred. Advantageously, the lignin-rich shell fractions obtainable after drying are present in readily separable and free-flowing form. It has been found that the cellulose-based fibers produced in this manner differ in their chemical composition in comparison with cellulose fibers and cellulose derivatives. While in cellulose fibers and cellulose derivatives virtually no further elements could be determined besides C, H and O, numerous elements such as N, S, P, Fe, C, Na, Ca, K, Ni, Cl, Cu, as well as other elements are present in cellulose-based fibers. Because of the binding properties found for the cellulose-based fibers, it is believed that these elements are at least in part associated with functional groups covalently bound either directly or indirectly to the polymeric framework structures. An indirect covalent bond may be present, i.e. via a sugar residue or a peptide. But it is also conceivable that non-covalently bound compounds are connected to the polymeric backbone via electrostatic binding forces, which have functional groups or elements. The presence of functional groups on the surfaces of the cellulose-based fibers is responsible for many of the effects found so far.

Both, the lignin-based shell particles, and the cellulose-based fibers, have large internal surfaces that result in the enormous water-binding capacity. As a result, they are particularly suitable for water binding and storage in soils used for cultivation. When dried, they can be excellently stored and transported. There is optimal miscibility with all soil types studied (e.g., loam, humus). The water absorption and water retention index were significantly increased by the addition of lignin-rich shell fractions in all investigated soils.

Preference is given to the use of lignin-rich shell fractions for improving the water retention and holding capacity of cultivation soils.

Lignin-based shell particles in the dried state have an excellent oil and fat absorbing effect and are therefore very well suited for the absorption of oils and fats, e.g. for adsorption from surfaces or from air/gas mixtures with oils and fats. The absorbed oils and fats do not exit spontaneously from the lignin-based shell particles, at the same time there is no “caking” of oil or grease saturated material, so that a very good transportability remains. It could also be shown that the adsorbed oils and fats could be completely removed from the lignin-based shell parts by using solvents and that thereafter they had a reuptake capacity for oils and fats that is unchanged compared to the starting situation. Lignin-based shell fractions have a low bulk density and can be flowed through by a stream of air or gas without much resistance. It could be shown that this property can be used to remove almost completely the oil or fat droplets from air or gas mixtures containing vapors of oils and fats, such as the exhaust air from deep fat fryers. Thus, lignin-based shell fractions are outstandingly suitable as oil separators or oil adsorbers from surfaces or the uptake from air/gas mixtures.

Preference is given to the use of lignin-based shell fractions for adsorption and binding of oils and fats from surfaces and from air/gas mixtures.

Preference is given to the use of lignin-rich shell fractions and/or cellulose-based fibers, with an oil and/or fat binding capacity of >200% by weight, for the absorption of fats and oils.

Surprisingly, the cellulose-based fibers obtained by the processes according to the invention showed particular properties which differ from those of cellulose fibers that were derived from the pulping processes of wood. For example, it could be shown that using the same cellulose-based fibers both hydrophilic and hydrophobic compounds could be applied to/in the cellulose-based fibers prepared according to the invention. Furthermore, it has been shown that after drying the cellulose-based fibers treated in this manner, there was a markedly delayed release of the attached or entrapped hydrophilic or hydrophobic compounds. This was especially the case when applied layer-wise to a carrier material or a layered material structure was obtained.

Thus, a method can be provided with which plant cladding materials of plant-based seeds and grains can very easily, effectively and reliably be disintegrated/dissolved/unlocked and dispensed using aqueous disintegration/unlocking solutions in which compounds are dissolved that are biologically harmless and do not interfere with the products obtained or even improve the material value. The quality of the plant seeds, grains and kernels can be significantly improved by the inventive gentle removal of the cladding material of the plant-basted starting material compared to processes of the prior art, in particular, the integrity of the treated seeds, grains and kernels is maintained. At the same time, a sensory aspect of plant seeds, grains and kernels, e.g. in the sense of debittering, can be improved. Furthermore, the method can also be used for further unlocking of the treated plant-based starting materials. In addition, valuable substances can be extracted and recovered from the disintegrated/dissolved or unlocked plant-based cladding materials, for example vitamins or antioxidants. In particular, the thereby decompacted cellulose-based fibres are obtainable, which have special physical properties and are due to the excellent sensory effects very well suited for the preparation of foods and meals.

Thus, a simple feasible and cost-effective and product-gentle method for disintegration/unlocking of plant material can be provided, which is universally applicable and biologically safe.

### Definitions

Starting Materials

The term “starting materials” as used herein includes all biogenic products having one or more types of tissue which demarcate or delineate, partially or completely enclose or connect or which represent a composite material structure. The term “plant-based cladding material” (pericarp) is in particular understood as all demarcating or delineating, in parts or completely enclosing or connecting tissue structures which are separable as a layer and are generally referred to as a membrane, seed coat, skin, sheath, peel, shell, septum or husk. The term is not limited to a particular material composition of the type of tissue of the plant-based cladding material referred to herein. In principle, the starting materials may have any proportion of the different constituents as well as other constituents and compounds. Typical constituents include, in particular, biopolymers, such as cellulose or lignin, which may be present in various compositions and various types of tissues/composite structures. The composite structures are preferably in a gap-free compact form of one or more of the constituents.

Preferred starting materials are plant-based sources such as seeds, grains, kernels, nuts, beans, bulbous plants, tubers, plants, fruits or roots.

These may be present in the form of unripe, ripening, ripened, overripe, aged or even damaged starting materials. Also suitable are contaminated or spoiled plant-based starting materials. The plant-based starting material may be in a completely intact form, damaged, crushed, peeled, pressed, ground, or otherwise disintegrated, including but not limited to milled or grounded flour, which may result, for example, from a mechanical extraction of oils, so-called press cake. These include also starting materials and in particular plant-based starting materials, which previously have undergone a thermal and/or liquid extraction process, for example using an alcohol or an organic solvent, such as hexane. Also included are plant-based starting materials in which a thermal treatment has taken place. These also include plant products obtainable from a digestion and/or fermentation process, in particular when they are waste materials (byproducts), such as brewery residues (for example in the form of spent grains or flour from spent grains) or marcs or olive pomace from must production. In addition, residues of cocoa beans.

Preference is also given to residues of press residues which are found, for example, in the production of juices (for example apple, tomato or carrot juice) or pomace, i.e. of grapes or apples or extracts, as obtained in the production of jellies or liqueurs (e.g. blackberry jelly, cassis).

Further, products of plant-based starting materials deriving from a peeling, dehulling or deseeding process may be used.

Under this definition fall in particular all plant seeds, such as linseed, poppy seeds, chia, amaranth, chili, tomatoes, anise, heath pea; Grains, e.g. of rapeseed, camelina, oats, hemp, wheat, buckwheat, rye, barley, maize, sunflowers, freekeh, jatropha; Fruit seeds/pits, e.g. from apples, pears, grapes, oranges, cherries, plums, apricots, peaches, whitty pear, medlars, mirabelle plum, rowanberries, pumpkins, melons, avocados; Beans such as soybeans, field beans, mats beans, mung beans or kidney beans, coffee beans, peas, lentils, e.g. Duckweed lenses, lupins or sesame seeds; Vegetables such as cauliflower, broccoli, kohlrabi, zucchini, peppers, artichokes or okra; bulbous plants, such as carrots or sugar beet; Fruits, such as apples, pears, quince, bananas, breadfruit, mango, kiwi, passion fruit, melons, passion fruit, figs, pumpkin, pineapple, avocado, olives, mango, chayote, guava, papaya, tamarillo, marmota apple, grape fruit, oranges, lemons or grapes; Berries such as rose hips, gooseberries, blueberries, blackberries, strawberries, elderberries, currants, cranberries, mulberries, apples berries, raspberries, blackberries, sandorn; tuberous plants and roots, such as potatoes, beetroot, batata, turmeric, cassava, horseradish, celery, radishes, ginger, arakascha, taro, wasabi, yacon, salsify, asparagus, parsnip, Brassica rapa subsp, Jerusalem artichokes, cattail, swede, Siberian angelica, yam root, yam, sunflower root, garlic, onions, devil's claw or ginko; as well as cucumbers, such as salad or pickled cucumbers, as well as eggplant or zucchini, and acorns; Nuts, such as almonds, hazelnuts, peanuts, walnuts, cashew nuts, Brazil nut, pecans, pistachios, chestnuts, sweet chestnuts, dates or coconuts. Furthermore, sugarcane.

Preference is given to dried starting products. Pre-shredding by a mechanical method is preferred. Preference is given to a GMO-free plant-based starting material for the production of GMO-free products. The main constituents of plant seeds, grains and kernels consist of proteins, carbohydrates, cellulose-based fibers and lignin-rich shells. In addition, they comprise, among others, vitamins, phytosterols, minerals, antioxidants, flavors and colorants.

Cellulose-Based Fibers

As used herein, the term “cellulose-based fibers” encompasses all of the basic structures of the parent plant materials consisting of a cellulose backbone having at least two of the following characteristics:
an origin of a plant-based material
an aspect ratio of a longitudinal and transverse diameter of 1:1 to 1000:1
a water binding capacity of >200% by weight
a proportion of chemical compounds and functional groups of >2.5% by weight which do not correspond to the elements C, H or O.

The cellulose-based fibers may already be loosely bound to or may be present with other compounds or components, such as matrices that are broken or broken apart by a pressing or crushing process, which is the case in pressed oilseeds or ground grain or they are in a stable composite structure, which prevents dispension of the cellulose-based fibers, such as is the case in vegetables or fruits.

In a starting material that has not been treated according to the invention, however, the cellulose-based fibers are present in the form of gap-free, compacted (closely bound) material (composite) with other constituents of the starting material that are not susceptible to being dissolved.

This compacted composite contains soluble proteins and carbohydrates. Such cellulose-based fibers are thus present in a compacted, inaccessible form. The cellulose-based fibers according to the invention have a three-dimensional volume and surface structure when they are decompacted. They might be combined in a composite structure with other solids, e.g. lignin-rich shells, which can be separated into spherical or particulate fragments by physical means such as mechanical comminution and/or thermal treatment.

The cellulose-based fibers included in the definition are characterized by structural features and physical properties that are common to them. In the decompacted form, they have in particular spatial structures in the form of free fibers, nets (mesh) or three-dimensional tissue structures. The cellulose-based fibers according to the invention preferably have a planar and/or particulate geometry. In particular, they are characterized by a low weight per length of <20 mg/100 m. They may include or encapsulate colorants or pigments can be structural constituents of the fibers according to the invention. However, other organic or inorganic compounds may also be constituents of the cellulose-based fibers or may be bound to them in that they are not detachable by an aqueous medium. The cellulose-based fibers which are obtained in the decompacted form with the processes according to the invention have these properties, which can be assessed by methods of the prior art.

Lignin-Rich Shell Fractions

As used herein, the term “lignin-rich shell fractions/parts” or “lignin-based shells” encompasses all of the shell and support structures of the plant-based starting materials having a lignin content of >30% by weight. The preferred lignin-rich shell fractions have a lignin content of >40% by weight, more preferably >50% by weight, more preferably >60% by weight, even more preferably >75% by weight and most preferably >90% by weight. They have no specific outer shape, which can be flat and polymorphic to particulate and round. The dimensions depend on the manufacturing process and can range from a few micrometers to a few millimeters. Lignin-rich shell fractions are present, for example, in press residues of rapeseed or jatropha seeds in a weight fraction of 8 to 15% by weight.

Disintegration/Unlocking Process

The term “disintegration” herein includes all processes that lead to disruption/division/unlocking of the water-impermeable structures or tissue of the starting material, resulting in the creation of cracks, voids, or crevices of the cladding layers, such as seed coat or covering materials of the plant-based starting material, up to a complete solvation/division of different types of tissue resulting in exposure of the enclosed surfaces of the seeds, grains or kernels of the plant-based starting material. It is crucial that hydration is accomplished by disintegration of the cladding material (seed coat) thereby the gap between the disintegrated seed coat material and the surface of the enclosed seed, grain or kernel is assessable to the aqueous solutions. This also includes a partial or in parts and/or local or complete disruption/division of the plant-based cladding materials to expose/release the individual components of the plant-based seed coat material.

The disintegration referred to herein also refers to the plant-based starting material that is/was encased by the seed coats and shells. This also results in a disruption/division/detachment of the constituents of the starting material, which is caused by hydration of their constituents. Disintegration as referred to herein means hydration of the constituents, which are connected to one another and/or different constituents are connected to each other by covalent or electrostatic forces, as in gap-free composite structures or hornified cellulose aggregates, thereby unlocking the individual constituents and releasing them so that they can separate spontaneously into an aqueous dispensing volume or be separated from one another by gentle shearing. The herein referred to “aqueous unlocking process”, which herein is also referred to simply as “unlocking”, is given when, by hydration of individual compounds/constituents, the binding energy to other compounds/constituents has been reduced to a level that the hydrated compounds/constituents can be spontaneously dispensed in a water phase or separated from each other by a low energy input. Therefore, the terms “disintegration” and “process for unlocking” as used herein may also be used interchangeably.

Aqueous Disintegration/Unlocking Solution

By the term “aqueous disintegration solution” or “aqueous unlocking solution” is meant herein, an aqueous solution of solutes for disintegration and for disruption/unlocking of constituents of the starting material. In a preferred method embodiment, the substances for disintegration or for disruption/unlocking of constituents of the starting material are one or more amino acid (s) and/or peptide (s) present in water in a completely dissolved form. The water may be clarified, clarified and purified process water, deionized, partially deionized, well or city water. The preferred substances present in a dissolved form for disruption/unlocking of constituents of the starting material are naturally occurring amino acids and/or peptides consisting of or containing these amino acids. The aqueous unlocking solutions according to the invention are preferably solutions of one, two or more amino acid (s) and/or peptide (s) which are present in the individual and/or total concentration in a range from 10 μmol/l to 3 mol/l, more preferably between 1 mmol/l and 1 mol/l and more preferably between 0.1 mol/and 0.5 mol/l. These may be L- or D-forms or racemates of the compounds. Preferred is the use of the L-form. Preferred are alanine, arginine, asparagine, aspartic acid, glutamine, glutamic acid, glycine, histidine, isoleucine, leucine, lysine, phenylalanine, proline, serine, threonine, tryptophan, tyrosine and valine. The amino acids arginine, lysine, histidine and glutamine are particularly preferred. Further preferred are derivatives of the aforementioned amino acids. The peptides which can be used according to the invention may be di-, tri- and/or polypeptides. The peptides of the invention have at least one functional group that bind a proton or can bind one. The preferred molecular weight is less than 500 kDa, more preferably <250 kDa, more preferably <100 kDa and particularly preferably <1,000 Da.

The preferred functional groups are in particular a gunanidine, amidine, amine, amide, hydrazino, hydrazono, hydroxyimino or nitro group. The amino acids may have a single functional group or contain several of the same class of compounds or one or more functional group(s) of different classes of compounds. The amino acids and peptides according to the invention preferably have at least one positively charged group or have a positive total charge. Therefore, cationic amino acids are particularly preferred.

Particularly preferred peptides contain at least one of the amino acids arginine, lysine, histidine and glutamine in any number and sequential order. Particular preference is given to amino acids and/or derivatives of these which contain at least one guanidino and/or amidino group. The guanidino group is the chemical residue H2N—C(NH)—NH— and its cyclic forms, and the amidino group is the chemical residue H2N—C(NH)— and its cyclic forms. These guanidino compounds and amidino compounds preferably have a water distribution coeficient (Kow) between n-octanol and water of no more than 6.3 (KOW <6.3). Particularly preferred are arginine derivatives. Arginine derivatives are defined as compounds having a guanidino group and a carboxylate group or an amidino group and a carboxylate group, wherein guanidino group and carboxylate group or amidino group and carboxylate group are separated by at least one carbon atom, i. e. at least one of the following groups is located between the guanidino group or the amidino group and the carboxylate group: —CH2-, —CHR—, —CRR′—, wherein R and R′ independently represent any chemical residues. Of course, the distance between the guanidino group and the carboxylate group or the amidino group and the carboxylate group can also be more than one carbon atom, for example in the following groups —(CH2)n-, —(CHR)n-, —(CRR′)n-, where n=2, 3, 4, 5, 6, 7, 8 or 9, as is the case, for example in amidinopropionic acid, amidinobutyric acid, guanidinopropionic acid or guanidinobutyric acid. Compounds having more than one guanidino group and more than one carboxylate group are, for example, oligoarginine and polyarginine. Other examples of compounds included in this definition are guanidinoacetic acid, creatine, glycocyamine. Preferred compounds have as a common feature the general formula (I) or (II)

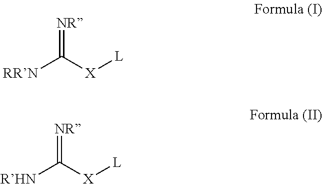

Whereas

R, R′, R″, R″′ and R″″ represent independently from each other —H, —CH═CH₂, —CH₂—CH═CH₂, —C(CH₃)═CH₂, —CH═CH—CH₃, —C₂H₄—CH═CH₂, —CH₃, —C₂H₅, —C₃H₇, —CH(CH₃)₂, —C₄H₉, —CH₂—CH(CH₃)₂, —CH(CH₃)—C₂H₅, —C(CH₃)₃, —C₅H₁₁, —CH(CH₃)—C₃H₇, —CH₂—CH(CH₃)—C₂H₅, —CH(CH₃)—CH(CH₃)₂, —C(CH₃)₂—C₂H₅, —CH₂—C(CH₃)₃, —CH(C₂H₅)₂, —C₂H₄—CH(CH₃)₂, —C₆H₁₃, —C₇H₁₅, cyclo-C₃H₅, cyclo-C₄H₇, cyclo-C₅H₉, Cyclo-C₆H₁₁, —C≡CH, —C≡C—CH₃, —CH₂—C≡CH, —C₂H₄—C≡CH, —CH₂—C≡C—CH₃,

or R′ and R″ together compose the residue —CH₂—CH—, —CO—CH—, —CH₂—CO—, —CH═CH—, —CO—CH═CH—, —CH═CH—CO—, —CO—CH₂—CH₂, —CH₂—CH₂—CO—, —CH₂—CO—CH₂— or —CH₂—CH₂—CH₂—;

X represents —NH—, —NR″″—, or —CH₂— or a substituted carbon atom; and

L represents a C₁ to C₈ linear or branched and saturated or unsaturated carbon chain having at least one substituent selected from the group including or consisting of

—NH₂, —OH, —PO₃H₂, —PO₃H—, —PO₃²⁻, —OPO₃H₂, —OPO₃H⁻, —OPO₃²⁻, —COOH, —COO⁻, —CO—NH₂, —NH₃⁺, —NH—CO—NH₂, —N(CH₃)₃⁺, —N(C₂H₅)₃⁺, —N(C₃H₇)₃, —NH(CH₃)₂⁺, —NH(C₂H₅)₂⁺, —NH(C₃H₇)₂⁺, —NHCH₃, —NHC₂H₅, —NHC₃H₇, —NH₂CH₃⁺, —NH₂C₂H₅⁺, —NH₂C₃H₇⁺, —SO₃H, —SO₃, —SO₂NH₂, —C(NH)—NH₂, —NH—C(NH)—NH₂, —NH—COOH, or

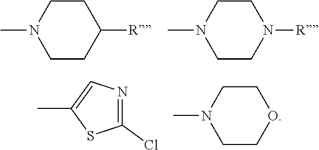

It is preferable that the carbon chain L is in the range from C₁ to C₇, more preferably in the range from C₁ to C₆, further preferably in the range from C₁ to C5, and most preferably in the range from C₁ to C₄.

Preferably L represents —CH(NH₂)—COOH, —CH₂—CH(NH₂)—COOH, —CH₂—CH₂—CH(NH₂)—COOH, —CH₂—CH₂—CH₂—CH(NH₂)—COOH, —CH₂—CH₂—CH₂—CH₂—CH(NH₂)—COOH, or —CH₂—CH₂—CH₂—CH₂—CH₂—CH(NH₂)—COOH.

Also preferred are compounds of the general formula (III) as shown below:

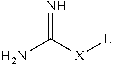

wherein the residues X and L have the meanings as disclosed herein.

Also suitable are di-, tri- or oligipeptides as well as polypeptides which are composed of one, two or more amino acids. Preference is given to short-chain peptides, e.g. RDG. Particularly preferred are peptides which consist of amino acids which have both hydrophobic and hydrophilic side groups, such as (designations according to amino acid nomenclature) GLK, QHM, KSF, ACG, HML, SPR, EHP or SFA. Further particularly preferred are peptides which have both hydrophobic and cationic and/or anionic side groups, such as RDG, BCAA, NCR, HIS, SPR, EHP or SFA. Further examples with 4 amino acids are NCQA, SIHC, DCGA, TSVR, HIMS or RNIF or with 5 amino acids are HHGQC, STYHK, DCQHR, HHKSS, TSSHH, NSRR. Particularly preferred are RDG, SKH or RRC.

For the unlocking/disintegration solutions according to the invention, it is possible to use or include further substances which are completely dissolved therein. Particularly preferred substances are: sulfites, such as sodium sulfite or sodium bisulfite and/or urea and/or carbonates, such as sodium carbonate or sodium bicarbonate. Furthermore, substances for adjusting the pH of the solution, in particular a base or acid, such as urea or NaOH, sodium carbonate, sodium bicarbonate or triethylamine or acetic acid or uric acid or substances with surfactant properties, such as DMSO or SDS. Also included herein are stabilizers such as antioxidants or reducing agents. Further, preferred substances which enable disintegration of constituents of the starting material are substances selected from the group of sulfites and sulfates. Particularly preferred are sodium sulfite and sodium bisulfite. Furthermore, cationic nitrogen compounds, such as diethylamine or triethylamine.

In the aqueous disintegration/unlocking solutions, the listed substances may be present in dissolved form individually or in any desired combination with one another and/or together with other substances. The preferred concentration of a single substance present in dissolved form is between 0.001 and 30% by weight, more preferably between 0.01 and 15% by weight and more preferably between 0.1 and 10% by weight. The pH of the aqueous solutions preferably ranges from 7 to 14, more preferably from 8 to 13, and more preferably from 8.5 to 12.5.

Decompaction

By the term “decompaction” as used herein is meant a partial or complete unlocking/disruption of a gap-free composite of like or different constituents, thereby separating these constituents and/or forming cleavage spaces containing a gaseous or a liquid medium. The decompacting as referred to herein means, in particular, the hydration that leads to the unlocking of insoluble fiber-like and/or tissue-like structures of cellulose-based fibers and lignin-rich shells, which allows separation of the soluble constituents into an aqueous dispension solution, thereby allowing removal of the decompacted water-insoluble cellulose-based fibers which are free or almost free of water-soluble compounds.

Dispensing Solution

The term “dispensing solution”, which is used synonymously herein with the term “dispensing volume”, is meant as a water phase which is added to a reaction mixture that enables dispensing and separation of soluble dissolved, soluble solid and complex insoluble constituents of the starting material. In a dispensing volume according to the invention, these constituents are present in a readily separable form. The presence of a sufficiently large dispensing volume may be tested by sampling to determine the separability of the dissolved and suspended constituents using the techniques and methods as described herein.

Condensation/Aggregation/Complexation

The terms “condensation/aggregation/complexing” summarize all physical and/or chemical processes that allow identical and/or dissimilar organic and/or inorganic compounds to be combined, resulting in condensates or aggregates or complexes that can become a solid and separated from an aqueous water phase by means of suitable separation processes. The term “condensate” is understood to mean the unification of macromolecular structures, which thereby form a measurable volume. The binding forces are electrostatic through hydrophobic or hydrophilic binding energies. In general, “aggregation” means an accumulation or clustering of atoms or molecules and/or ions into a larger compound structure, the aggregate. The accumulation or clustering is effected by van der Waals forces, hydrogen bonding, and/or other chemical or physicochemical bonding modes. The term “complexes” as used herein means macroscopically visible formation of condensates and/or aggregates that are combined forming a larger composite structure. From the condensates/aggregates and complexes due to the low binding energies, the individual compounds can easily separated or isolated from the composite structures, e.g. by a mixing process. In contrast, coagulates are three-dimensional structures of small to macromolecular compounds that arise through a chemical reaction in which covalent bonds between the molecular structures are formed and/or cleaved. In the case of a coagulate, the individual compounds can not be separated from one another or isolated only to a small extent by dissolution in water. The condensation/aggregation/complexation referred to herein is different from coagulation, which is in particular a precipitation reaction of a (strong) acid in which the original tertiary structure of the proteins, is partly or completely denatured. This is not the case with the aggregation/complexation or condensation according to the invention. For example, the water binding capacity of denatured compounds is significantly lower than in the condensates/aggregates and complexes referred to herein.

Complexing/Aggregation Agent

By the term “complexing agent” or “aggregating agent” is meant herein one or more organic and/or inorganic substances which initiate, maintain and/or accelerate a condensation/aggregation/complexing of constituents/organic compounds dissolved in water in an aqueous mixture. Those agents can have, among others, a catalytic, destabilizing, displacing and/or releasing effect on the constituents to be condensed/aggregated or complexed, which leads to an aggregation/complexing of the constituents/organic compounds. The substances may also cause this effect by a change in pH and/or salinity and/or even by getting themselves involved in the aggregation/complexation process.

The preferred aggregating agents include in particular organic acids, particularly preferred are citric acid, ascorbic acid, lactic acid, adipic acid, EDTA. Furthermore, inorganic acids, particularly preferred is phosphoric acid. Further, calcium, magnesium and aluminum ions, preferably in the form of a salt, e.g. calcium chloride or magnesium chloride are provided. Further, carbonate anions, which are preferably provided in the form of salts, e.g. sodium carbonate or sodium bicarbonate. Furthermore, silicate anions, which are preferably provided as a dissolved salt, e.g. sodium metasilicate.

The complexing agents can be applied in the form of a solid, preferably in the form of a fine powder or in an aqueous medium in completely dissolved form. Aqueous solutions are preferred. The concentration is preferably in a range from 1 mmol to 5 mol/l, more preferably between 100 mmol and 3 mol/l and more preferably between 200 mmol and 2 mol/l.

Constituents of the Starting Material/Organic Compounds

The terms “constituents of the starting material” and “organic compounds”, which are used interchangeably herein, include all organic compounds of biogenic origin from which the starting materials referred to herein and which are derived from, respectively, and which can be unlocked and separated from the biogenic starting materials by any of the methods described herein. These may be individual compounds, e.g. in the form of molecules or complex compounds, e.g. in the form of polymers. According to the different origins, organic compounds of various groups of substances are found which may be present individually, but usually in varying combinations and in different proportions. In the following, therefore, only the main groups of substances to which the organic compounds can be assigned, without being restricted to these, are listed: Proteins, including albumins, globulins, oleosins. Furthermore, lipids, such as mono-, di- or triglycerides, waxes, wax acids, hydroxy- and mycolic acid, fatty acids with cyclic hydrocarbon structures, such as shikimic acid or 2-hydroxy-11-cycloheptyl-li-nicanoic acid, mannosterylerythritol lipid, dyes, such as carotenes and carotenoids, chlorophylls, and their degradation products, phenols, phytosterols, in particular R-sitosterol and campesterol and sigmasterol, sterols, sinapine, squalene. Phytoestrogens, e.g. isoflavones or lignans. Carbohydrates which are present in polymeric form and are water-insoluble, such as cellulose or in complexed form, such as starch or in water-soluble form, such as glucose or fructose. Furthermore, steroids and their derivatives, such as saponins, furthermore glycolipids and glycoglycerolipids and glycerosphingolipids, furthermore rhamnolipids, sophrolipids, trehalose lipids, mannosterylerythritol lipids. Also polysaccharides, including pectins such as rhamnogalacturonans and polygalacturonic acid esters, arabinans (homoglycans), galactans and arabinogalactans, as well as pectic acids and amidopectins. Furthermore, phospholipids, in particular phosphotidylinositol, phosphatides, such as phosphoinositol, furthermore long-chain or cyclic carbon compounds, furthermore fatty alcohols, hydroxy and epoxy fatty acids. Likewise glycosides, lipo-proteins, phytate or phytic acid as well as glucoinosilates. In addition, vitamins, e.g. Retinol, (vitamin A) and derivatives such as retinoic acid, riboflavin (vitamin B2), pantothenic acid (vitamin B5), biotin (vitamin B7), folic acid (vitamin B9), cobalamins (vitamin B12), calcitriol (vitamin D) and derivatives, tocopherols (vitamin E) and tocotrienols, phylloquinone (vitamin K) and menaquinone. Furthermore tannins, terpenoids, curcumanoids, xanthones. But also flavorings, or odors and flavors, dyes (colorants), phospholipids and glycolipids, waxes or wax acids and fatty alcohols. Furthermore, water-insoluble biopolymers, such as lignins and cellulose, which are preferably in the form of tissue/fabric-like composite structures.

Proteins

By the term “proteins” as used herein is meant macromolecules consisting of amino acids linked together by peptide bonds. The proteins referred to herein have >100 amino acids. They may be present in their primary structure, secondary structure or tertiary structure as well as in a functionally active form. In the case of the secondary structure, the spatial geometry may be in the form of an α-helix, β-sheet, β-loop, β-helix or randomly as random-coil structures. Also included herein are supramolecular compounds of proteins, such as collagen, keratin, enzymes, ion channels, membrane receptors, genes, antibodies, toxins, hormones or coagulation factors. According to the ubiquitous occurrence in all life forms and areas of life, the proteins referred to herein may be macromolecular compounds in any of the stated forms, irrespective of the physiological task which they originally had, and which served for example for, shaping, supporting, transporting, or defending, or for reproduction, energy production, or energy transport or for reaction promotion/reaction turn over. By this is meant, in particular, the proteins as defined above which are extractable from the starting materials described herein.

Methods

Method of Providing Plant Starting Material.

According to the different origin and extraction possibilities of the starting materials which can be used according to the invention, these can be present in different forms and states. For example, whole/intact seeds, grains, kernels, nuts, vegetables, fruits, blossoms, ovaries or roots can be involved and/or consists of wholegrain or partially disrupted, broken, comminuted, powdered, crushed or pressed plant materials and/or plants materials which have partially or completely undergone a fermentative or disintegrative process, in particular by an autolysis/microbial degradation/chemical-physical reaction, and/or are residues from agricultural production/food production or utilization. The broken, split, comminuted, powdered or liquidized or dissolved plant-based starting materials may be presented as contiguous or discrete pieces or may be aggregated, e.g. as pellets or pressed material or be present as a loose composite, such as granules or bulk material or in isolated form, such as a flour or powder or in the form of a suspension. The consistency, shape and size of the plant-based starting materials is in principle irrelevant, but preferred are comminuted plant starting materials that allow easier unlocking. Preferably, maximum diameters of the dispensible particles of the plant starting materials are between 100 μm and 100 cm, more preferably between 0.5 mm and 50 cm, more preferably between 1 mm and 20 cm and more preferably between 2 mm and 5 cm. The form of the suitable plant-based starting materials is arbitrary, as well as the consistency, which may be hard or soft, or it may be in a liquid form. In this case, the starting material may have any desired temperature, preferably a heated starting material, as obtained, for example, following a pressing procedure. Unless the plant starting material meets the appropriate properties/requirements for one of the process operations of the present invention, these conditions can be established by methods available from the prior art. These include, in particular, methods which enable and/or facilitate the unlocking of the plant starting material according to the invention. These include, in particular, mechanical processes with which the plant starting material can be comminuted. In this case, it may be necessary, in particular for process economization, to first comminute and then dry or to dry the plant material and then comminute it. In one process embodiment, the comminuted and then dried plant starting material is comminuted to a certain particle size before process step a), preferable are particle sizes between 10 μm and 2 cm, more preferably between 30 μm and 5 mm. According to the invention, however, comminution can also take place during or after the addition of a disintegration/unlocking solution. In one process embodiment, lignin-containing components of the plant starting materials are first removed mechanically. These may be, for example, cladding materials of the plant-based starting materials, such as skins, husks or peels, such as those of apple or grape seeds. For this purpose, mechanical methods are known from the prior art.

The starting materials are filled in a suitable container, which can preferably be filled from above and has a closable outlet at the bottom.

Methods for the Preparation and Use of Aqueous Solutions for Disintegration and for the Unlocking of the Starting Material

The unlocking solutions according to the invention are prepared using the unlocking substances according to the invention as defined herein. For this purpose, one or more of the substances are dissolved in water, wherein the water may be a clarified process water, a completely ion-free water and well or city water. For dissolution it may be necessary to raise the temperature and/or continue mixing for up to 2 days. Preferably, a pH of the cationic amino acid or peptide solution ranges from 7 to 14, more preferably between 8 and 13, and more preferably between 8.5 and 12.5. In one embodiment, the pH can be adjusted to any pH range between 6 and 14 by the addition of an acid or a base. Acids and bases known in the art may be used, such as caustic soda or HCl.

Methods for carrying out method step b): Adding a disintegration solution to the starting material and leaving it in the disintegration solution until disintegration is achieved.

In this process step, the wetting of the surfaces of the constituents within the plant starting material must be ensured. This can be done with prior art methods on intact or disintegrated plant starting materials. The unlocking solutions can be prepared at any temperature and added to the starting material. The application may be carried out in droplet form, e.g. as an aerosol, dropwise or jet, continuously or discontinuously toward, into and/or onto the starting material.

In a preferred embodiment, this is done under exclusion of air and/or under inert gas conditions. Preference is given to placing the plant material to be disintegrated into an aqueous unlocking solution. The application is carried out by feeding an adjustable quantity of a prepared unlocking solution from a reservoir via a supply line to the starting material.

A disintegrated form of cladding material and shells exists when the cladding material or shells can be detached/separated from the plant starting material, in whole or in part, spontaneously, for example, in an aqueous dispensing volume or by a jet of water or by a slight mechanical force. A disintegration of constituents of the cladding or shell material or the constituents of the starting material is present if the individual constituents of the starting material are dissolved out of or dispensed from a solid and water-insoluble composite or from a surrounding composite structure (e.g. shells). Separated in this context means that the individual compounds/constituents can be spontaneously separated in an aqueous dispensing volume. Dissolvable here means that the disintegrated or unlocked constituents or compounds are easily and completely isolated by a low energy input in an aqueous dispensing volume. Physical methods, such as heating or mechanical reduction, can also be used for this purpose.

In principle, thermal disintegration is advantageous if the plant starting material has a high water content, as this is the case in fresh fruits and plants. Here, the disintegration is preferably carried out by a transfer of thermal energy by water or water vapor. Preferably, pressurization is carried out at the same time.

A mechanical disintegration is particularly advantageous if the plant starting materials have a low water content and/or are enclosed in cladding layers/shells that are impermeable to water. Furthermore, a mechanical method is preferable when first another fraction of the plant starting material, such as oil, should be removed from it first.

In a preferred process embodiment, disintegration is carried out by complete or partial mechanical comminution of the starting material. The comminuted material is then placed in a water bath and heated until the proportion of the starting material representing the recoverable constituents of the starting material is so soft, that by the use of a slight force, such as by crushing with the fingers, the constituents become mushy or a liquid phase. This is particularly advantageous if, owing a different degree of strength of the various structures, for example, the mesosperm and the shell, those structures can easily be differentiated from one another and mechanically separated following one of the abovementioned disintegrating forms. In a preferred embodiment, the heating takes place together with a pressure increase in an autoclave. In a preferred embodiment, plant cladding materials are removed before and/or after disintegration of the plant starting material. In a particularly preferred embodiment, the plant starting material is disintegrated by prior introduction into one of the aqueous solutions according to the invention, comprising an aqueous disintegration/unlocking solution according to the invention. In principle, the volume or weight ratio can be chosen freely, but it is advantageous if the plant starting material is completely wetted by the unlocking solution. Preferably, a water volume ratio of the aqueous unlocking solution to the mass of the plant material is between 0.3 to 30, more preferably between 0.5 and 20, more preferably between 0.7 and 10 and more preferably between 0.8 and 5. In a variant of the method, the plant material is impregnated with one of the unlocking solutions during the application of one of the disintegration methods or immediately afterwards. In one process variant, the impregnation is carried out directly together with compounds that enable/accelerate disintegration of the plant starting material. The duration of exposure to the unlocking solution depends on the plant source materials used. Preferred is a duration between 1 minute and 48 hours, more preferably between 10 minutes and 14 hours and more preferably between 20 minutes and 6 hours. The temperature at which the exposure of the plant starting material is carried out with the aqueous unlocking solutions is, in principle, freely selectable. Preferably, a temperature between 5° and 140° C., more preferably between 10° and 120° C. and more preferably between 15° and 90° C. is chosen.

Methods for carrying out method step c): Dispensing of the constituents of the disintegrated starting material in a dispensing volume.

In a preferred embodiment, the cladding/shell material and/or plant starting material that has been disintegrated in a previous process step is solved in water to fully hydrate the separated constituents, thereby providing them in separable form and without any association/attachment to or by other constituents. The dispensing volume according to the invention is a volume of water which ensures the separability and separation of the cladding/shell material and/or the constituents of the starting material.

For the process of an unlocking/separation of cladding material, a very small volume of water may be sufficient, which is applied e.g. by means of a water jet. If disintegration and unlocking are carried out, the required dispensing volume must be sufficiently large to allow complete hydration of the constituents which are soluble or detachable and to ensure that the dissolved and insoluble constituents of the starting material can be separated. If it is an unlocking mixture, the determination of the required dispensing volume is preferably made by making a dilution series with a sample from the previous process stage (e.g., 10 g of the separation/unlocking mixture). After a stirring phase of 3 minutes, filtration (sieve size 100 μm) of the suspension is performed. The filter residue is analyzed (visually or microscopically) for deposits/attachments of soluble and water-rinsable compounds. The filtrate is then admixed with a suitable solution of an aggregating agent in increasing dosage. A sufficiently large dispensing volume is accomplished when there are no deposits/attachments to the solid constituents of the starting material that are present as filter residue, and there is complete condensation and/or aggregation and/or complexation of the dissolved soluble constituents present in the dispensing mixture.

Preferred is a ratio of the water volume to the dry mass of the starting material of 5:1 to 500:1, more preferably from 10:1 to 150:1 and more preferably from 15:1 to 50:1. For this purpose, clarified/purified process water of consecutive process steps can be used or deionized or not further treated city or well water.

The type of introduction or contact of the separation/unlocking mixture and the water phase of this process step is arbitrary. Preference is given to a process where the admixture of the water phase is performed by means of a high-performance shear mixer or another intensive mixer. This is particularly advantageous because it allows direct hydration and separation. Further preferred are stirring devices which cause turbulent flow, such as propeller mixers or jet mixers. The dispensing process can be continuous or discontinuous and at any temperature, preferably a temperature range of the aqueous suspension is between 6° and 90° C., more preferably between 10° and 60° C. and more preferably between 18° and 40° C. The duration of the dispensing process is arbitrary, preferred is a duration of 1 minute to 24 hours, more preferred from 5 minutes to 5 hours and more preferred from 10 minutes to 1 hour. The dispensing process of the process of unlocking of the constituents of a starting material is sufficient and complete when no visible aggregates of different constituents of the plant starting materials can be observed microscopically or visually on the filter residues from a representative sample taken from the dispensing mixture that is filtered through a coarse (1 mm mesh) and a fine sieve (100 m sieve). The successful dispensing of the constituents of the starting material can also be recognized by filling a sample of the dispensing mixture into a graduated cylinder and within a short time 3 phases or in the case of the presence of lipids 4 well-distinguishable phases have been separated. The time required for this should not exceed 4 hours.

The control and optional adjustment of the pH of the dispensing solution is in accordance with the invention. This can be done with bases or acids from the prior art, preferred acids are HCl or formic acid, preferred bases are NaOH or urea. Preferably, a pH of the dispensing solution is between 5 and 13, more preferably between 7 and 12.5 and more preferably between 7.5 and 11.

The volume of water required to carry out the following process steps according to the invention is provided in a suitable container.

Methods for carrying out method step d): Separation of solid constituents from dissolved constituents of the starting material.

The solid constituents of the starting material referred to herein are organic compounds which do not dissolve further as a result of one of the disintegration/unlocking processes according to the invention and which can be obtained as particulate structures by means of filtration and which do not pass through a sieve of 10 μm. The recovery of solid constituents is preferably accomplished by means of filtration techniques from the prior art. However, process techniques can also be applied in which a separation of the solid matter from the liquid mixture is achieved, for example by means of centrifugal acceleration, e.g. a sieving decanter or a cyclone separation techniqueis accomplished. After the process step d), the process liquid or the dispensing mixture contains preferably <5% by weight, more preferably <2.5% by weight and more preferably <1% by weight of solid matter having a maximum size of >10 microns.

Methods for carrying out the method step e) Obtaining the separated constituents of the plant starting material as fractions of materials for further utilization In a preferred embodiment, the fractions separated from one another in process step d) are fed to separate treatment stages:

e1) Fractionating of cellulose-based fibers from lignin-rich shells of the solid constituents of the plant starting material by means of an cyclone separation technique and obtaining pure fractions of cellulose-based fibers and lignin-rich shells,

e2) aggregation/complexation of dissolved proteins of the dissolved constituents of the plant-based material by complexing agent and separation of the sedimented aggregated/complexed condensed proteins to obtain an aggregated/complexed protein mass.

If only one recyclable fraction is to be obtained, only one of the two process steps can be used.

In method step e1), a separation of different or the same disintegrated solid matters is performed, which are preferably present in the form of cladding/shell material or of cellulose-based fibers and/or lignin-rich shells (fractions). In the case of separating different solids, this can be done by means of filtration techniques or cyclone separation technique. The filtration is preferably carried out by suspending the solid material in water and preferably passing the suspension under agitation of a sieve and/or of the suspension through sieves with different mesh sizes. In the cyclone separation technique is preferably also performed using suspensions of the fiber mass. The water phases emerging from the upper and lower drain of this separation device are filtered and the sieve fractions are recovered. Preferably, the use of a volume ratio of the process solution to the volume of the plant material from process step b) is between 0.1:1 and 10,000:1, more preferably between 0.5:1 and 1,000:1, more preferably between 1:1 and 500:1 and more preferably between 2:1 and 20:1. The process step is complete when, in a macroscopic or microscopic or analysis, the purity of the obtained different solids fractions is preferably >95% by weight, more preferably >97% by weight and more preferably >99% by weight.

The process step e2) can be carried out, provided that by a disintegration/unlocking process soluble constituents of the starting material have also been detached/dissolved and are in the process liquid of the previous process step that is cleaned/separated from solid matter.

In a preferred embodiment, this process step involves condensation and/or aggregation and/or complexing of the dissolved proteins and/or other dissolved organic and/or inorganic compounds of the filtrate of the preceding process step. The aim of this aggregation process is to bring about an aggregation of dissolved or hydrated constituents and in particular of the proteins, with formation of a condensed phase/mass which can be separated by means of known separation techniques in order to obtain them with as little water as possible.

Preference is given to an addition of one or more suitable aggregating agent (s). Suitable aggregating agents are, for example, acids, including preferably organic acids, such as, for example, acetic acid, ascorbic acid, citric acid, lactic acid, malic acid, but also inorganic acids, such as HCl, sulfuric acid or phosphoric acid, furthermore salts, such as, for example, NaCl, KCl, MgCl₂, CaCl₂ or NaSO₄, AlCl₃, also complexing agents, such as EDTA but also adsorbents, such as calcium oxide, magnesium oxide, kaolin or other clay minerals. Also preferred are soluble divalent cations, preferably of aluminum, calcium and magnesium salts. Furthermore, combinations of the aggregating agents listed herein are advantageous, such as a combination of citric acid and aluminum chloride. Further preferred are carbonates, such as sodium carbonate, sodium bicarbonate or calcium carbonate. Furthermore silicate compounds, especially sodium-metasilicate, sodium orthosilicate, as well as other soluble silicates. The pH of the aqueous solutions containing dissolved aggregating agents can in principle be chosen freely and depends on the effectiveness of the aggregation achievable therewith. When appropriate a buffer which adjusts the pH of the solution may also added be to a solution of the aggregating agent.

The suitability can be easily recognized by the person skilled in the art by adding and admixing, in increasing concentrations, different aggregating agents to samples of the fiber-free process solution of process stage d) and determining the completeness of the aggregation/complexing of the dissolved constituents. For this purpose, one or more of the aggregation solutions/aggregating agent is added and mixed with the supernatant that have been obtained after a centrifugal separation of the condensates. If there is no sediment after a reaction time of at least 10 minutes followed by centrifugation and the water phase is clear or almost clear, adequate aggregation/condensation of the dissolved constituents has taken place. In a further embodiment, the application of the aggregating agent (s) is performed as a solid, preference being given to the use of a powdered form which is added to the reaction mixture. Aggregation/complexation can be detected with the naked eye after a short residence time. The selection of the appropriate concentration may be made by centrifuging a sample solution which has aggregated/complexed/condensed and treating the supernatant again with the same and/or different aggregating agent solutions. If no visible condensates/aggregates/complexes can be formed and/or separated off, the solution contains <6% by weight, preferably <4% by weight and most preferably <2% by weight of dissolved proteins.

The aggregating agents are completely dissolved in water which is preferably ion-free or deionized. The concentration of the aggregating agent (s) depends on the process conditions and must be determined individually. Generally preferred is a concentration range from 1 mmol to 5 mol/l, more preferably between 100 mmol and 3 mol/l and more preferably between 200 mmol and 2 mol/l. The volume of the solution with one or more aggregating agent (s) or, in the case when different aggregating agents are used with different aqueous solutions, is performed continuously or discontinuously, dropwise or as a jet. Preferably, the reaction mixture is agitated; preferably the agitation is done utilizing slightly turbulent or laminar flow conditions, in order to avoid disintegration of the formatting condensates/aggregates/complexes. Preferably, thorough mixing of the reaction mixture is performed.

Preferably, a process control is carried out by a visual inspection of the condensation progress or by a process monitoring which is based on determination of the degree of turbidity during the progression of the clarification the water phase. The completeness of the condensation/aggregation/complexing of the dissolved compounds can be easily checked by the method described above and optionally adding one or more of the aggregating agents to the reaction solution. The duration of the mixing is in principle freely selectable. In a preferred method embodiment, mixing is only for the duration of the addition of one or more aggregation agents or for a duration of between 10 seconds and 5 minutes, more preferably between 20 seconds and 2 minutes.

The temperature at which condensation and/or aggregation and/or complexing occurs can in principle be chosen freely. Preferably, a temperature between 6° and 90° C., more preferably between 10° and 60° C. and more preferably between 18° and 40° C., is selected. Preferably, the pH is set to a certain range; the pH optimum results from the selection or combination of the aggregation agent(s). The optimum pH range can be determined by the method described above. The pH of the aqueous solution containing dissolved compounds in which the condensation and/or aggregation and/or complexing of the dissolved proteins and/or other dissolved compounds according to the invention takes place is preferably in a range between 5 and 13, more preferably between 6 and 12 and more preferably between 6.5 and 11.

In a particularly preferred embodiment, after the addition of one or more aggregating agents, a residence time is maintained during which no or only minimal mixing of the mixture is performed. The required time of the condensation phase can be determined, in an analogous manner, as described in the method herein, preferably this is between 5 minutes and 10 hours, more preferably between 10 minutes and 5 hours and more preferably between 15 minutes and 2 hours. If the residence time is to be reduced to a minimum, sufficient minimum duration of the residence time after addition of the aggregating agent can be easily verified on the basis of a sample which is centrifuged and treated in an analogous manner, as described above, for the completeness of condensation and/or aggregation and/or complexation that is achieved with the condensing agent (s).

The condensation phase is preferably carried out at ambient temperatures, preferably in a temperature range between 15° and 40° C. In further preferred embodiments, this takes place at a temperature between 5° and 15° C. on the one hand and between 40° and 90° C. on the other. The selection of a reduced temperature may be advantageous, for example, in the recovery of thermolabile compounds. The choice of a high temperature, e.g. 60° C., may be chosen, for example, to kill germs on microbial loading of the starting material, e.g. in the form of a pasteurization process. On the other hand, heating can also inactivate allergens and certain toxins as well as anti-nutritive compounds. In a preferred method embodiment, the condensed/aggregated/complexed proteins are made recoverable in the form of a sediment. Sedimentation is completed when no further sedimentation takes place. Preferably, the drainage of the sediment phase is via a bottom outlet and is fed to a further dehydration process or directly to a drying process, such as spray drying or grinding-drying process (TurboRotors) or freeze drying.

In a preferred process embodiment, the condensed/aggregated/complexed compounds of this process step are dehydrated to remove bound process water, to purify and/or condition these and/or make them easy to transport or formulate. The sediment obtainable at the end of this process step is preferably present as a suspension up to a viscous cream-like mass. Preferred is a dehydration, which is accomplished by means of filtration process techniques. Preferred is an application onto a belt-filter. The preferred filters have a screen size of 50 to 500 μm, more preferably from 80 to 350 μm and more preferably from 100 to 320 μm. Preferably, the filter belt fabric is made of polypropylene or other hydrophobic polymer material is used. Preferred devices are belt-filters, chamber filters, filter presses and chamber filter presses, as well as vacuum belt filters. Also preferred are centrifugal processes; centrifuges or decanters are particularly suitable. The residual water content of the obtainable dehydrated condensate mass can be selected in a process-specific manner, so that e.g. a flowable or spreadable or dimensionally stable protein mass is obtained. In principle, a complete as possible separation of the bound process water is desired. When using a decanter, the separation is preferably carried out at >2,000*g, more preferably >3,000*g and more preferably >3,500*g. Preferably, the residence time in a decanter is >10 seconds, more preferably >20 seconds and more preferably >30 seconds. Further preferred is a pressing process for removing bound process water. Preferably, removal of process water is carried out in a filter device with a water-permeable filter fabric/material. Preferably the already condensed or dehydrated mass is, for example, located in a filter chamber to which pressure is applied, whereby the residual moisture content can be reduced to the desired level. It is preferred to carry out the process at ambient temperatures, in a range between 15° and 40° C. In further advantageous embodiments, temperatures in the range between 5° and 15° C., and between 40° and 80° C. can be selected.

Preference is given to obtaining a dehydrated mass having a residual moisture content of <90% by weight, more preferably <80% by weight, more preferably <70% by weight and even more preferably <60% by weight and even more preferably <40% by weight.

Method for Testing the Water Retention Capacity

The water retention capacity can be determined by methods of the prior art. In one of the methods, the water content of a 0.5 g sample is determined and suspended in a 100 ml Erlenmeyer flask in 50 ml of distilled water. After agitation for 1 hour at 20° C., the free water phase is removed by loading onto a G3 glass frit, together with the glass frit, the sample material is centrifuged at 2,000*g for 15 minutes. The amount of centrifuged liquid and the sample weight are determined. The water retention value (WRR) is calculated according to the following formula

$$W R R ( \% ) = \frac{Sample wett material mass - sample dry mass}{Sample dry mass} \times 100$$

The hydration volume can be determined by mixing the obtained decompacted cellulose-based fibers (e.g. 100 g with a water content of 100% by weight) for 3 minutes by means of an intensive mixer in a water phase having a neutral pH and a volume ratio to the solid mass of the fibers of >1,000:1 and thereafter allowing free outflow of the unbound water phase through a sieve with a sieve mesh size of 50 μm. After 1 hour, the volume of the cellulose-based fiber mass is determined. Thereafter, mechanical dewatering and then drying to a residual moisture of <10% by weight is performed. After determination of the volume, the volume ratio is calculated. The oil retention capacity may be determined in an analogous manner by using a liquid lipid phase, e.g. paraffinic oil.

The water solubility (NSI) of proteins is determined according to the standard method AOCS 1990, (Daun and DeClercq, 1994)

Applications

The method is in principle applicable to all plant-based products. The application is in particular for the unlocking, solving/detachment of plant cladding material and for their partial or complete dissolution or decomposition.

The method is also suitable for solving or dissolving separated plant cladding material. For this purpose, preference is given particularly to skins, e.g. of potatoes, apples, pumkin, as well as husks or cores, e.g. of sunflowers or wheat seeds or of apples or pears. Preference is also given to a process in which plant cladding materials, such as skins, peels, husks, pods have been separated by one of the processes according to the invention or by another process, which has been separated with one of the processes according to the invention and are to be further dissolved by one of the interventional processes.

The method is therefore particularly suitable for the separation of cladding materials of plant seeds and kernels, especially if they are in a compacted form. The method is therefore particularly suitable for the solution or detachment of shells, pods or skins, e.g. dried nuts such as walnuts or hazelnuts, almonds, beans such as soybean or kidney beans, kernels such as apple, orange or grape seeds or even avocado or jatropha seeds, legumes such as rice, corn or peas and beans, dried seeds and kernels, such as rapeseed, sunflower, wheat, rye, oats, lupines, camelina.

By the method embodiments according to the invention, various preferred products can be produced. For example, skinned grains and kernels prepared under very mild conditions may be provided. By eliminating a temperature increase for the unlocking process, grains and cores with unchanged integrity of their constituents can be obtained. In particular, there is no formation of trans-fatty acids or thermal reaction products. In one embodiment, grains and kernels, but also other starting materials are obtained, which are enriched with amino acids and/or peptides. In a further method embodiment, by using this or another functionalization, an increase in the oxidation stability of the plant product is achieved.

In further advantageous embodiments, disintegrated cladding materials can be obtained which can be used in foods, e.g. as a separation layer or as a swelling substance in taste-neutral form. Such excellent shapeable and for the texturing of food suitable shell/fiber condensates has excellent swelling properties and water-binding capacity and thus serve also to keep food products fresh.

In further embodiments, pure fractions of their constituents are obtained from the cladding materials, which have not previously been obtainable and have excellent properties that can be used in numerous areas of life.

For lignin-based shell fractions excellent water retention capacity has been demonstrated. Therefore, a preferred application is the addition to grounds/soils to improve the water binding capacity, especially of cultivated soils. Thus, lignin-rich shell fractions are obtained, which can be used to improve soil quality especially in the area of crop cultivation, due to the high water binding capacity and the natural degradability and biocompatibility. Lignin-rich shell fractions are also useful for adsorption and/or storage/transport of lipid phases. They can therefore also be used for oil adsorption/separation. Furthermore, they are useful for formulating pet food products. Of particular value are lignin-based shell fractions, which obtain an abrasive cleaning effect through a disintegrative process and thus also surfaces can be treated/cleaned, which are scratch-sensitive. In this respect, a biogenic and biodegradable abrasive cleaning agent can be provided.

The cellulose-based fibers produced according to the invention can in principle be used in all areas of life as well as industrial processes and process sequences.

Cellulose-based fibers obtained and produced by the process of the present invention are particularly suitable for human nutrition applications. In particular, they are suitable as a dietary food additive for preparation of reduced-calorie food. In addition, cellulose-based fibers are suitable for dietary weight reduction. Additionally they are usable as a substitute or for the reduction of soluble carbohydrates, such as pectins or starch, in food preparations. Furthermore, they can be used as a substitute or for the reduction of oils or fats in food preparations. Cellulose-based fibers are suitable for regulating intestinal activity and altering/softening stool consistency. Further, they can be used as a dietary anti-constipation agent. Cellulose-based fibers can also be used in animals for stool control and dietary weight reduction. Furthermore, cellulose-based fibers are suitable for the thickening and stabilization of liquid or flowable foods and food preparations. Cellulose-based fibers increase the water-binding and retention capacity of food preparations. As a result, cellulose-based fibers are also suitable for keeping the water content longer in foods or food preparations, or keeping them fresh and reducing the risk of drying out. Further, cellulose-based fibers can be used to incorporate and/or stabilize substances/compounds or microorganisms in foods or food preparations. As a result, for example, labile compounds, such as vitamins or antioxidants, can be stabilized/distributed in food or preparations. Furthermore, by this means microorganisms can be introduced into foods that exhibit increased metabolic activity, such as yeasts or lactic acid-cleaving bacteria. These properties of the cellulose-based fibers can also be used to cultivate algae or other microorganisms and use them to produce substances/compounds or gases with increased efficiency.

Cellulose-based fibers produced according to the invention are particularly suitable for the preparation of lotions/creams/ointments or pastes for applications on skin or mucous membranes. In doing so, they enable improved water retention on the surface of the skin and mucous membranes as well as improved emulsifiability of hydrophilic and lipophilic compounds as well as the incorporation of compounds such as antioxidants or sunscreen compounds and lead to improved smoothness of skin and mucosal areas.

Furthermore, cellulose-based fibers are very well suited as separating agents for food products/food, which are cooked at high temperatures with methods for direct or indirect heating, such as roasting, baking, grilling or deep-frying.

Thus, cellulose-based fibers are applicable as a separating agent or as a substitute for breading/breadcrumbs, for example in preparations of meat or fish and meat or fish products, potato or dough preparations. Furthermore, cellulose-based fibers are suitable for formulating or preserving other nutrients or food ingredients. This is the case in particular in the production of protein products, such as protein concentrates or isolates. However, preparations with oils/fats and/or soluble or complexed carbohydrates or aromas and flavoring agents can be prepared and/or formulated and/or stored with the cellulose-based fibers according to the invention. Furthermore, cellulose-based fibers are suitable for effecting a long-lasting feeling of moisture on mucous membranes. Therefore, cellulose-based fibers are particularly suitable for treating a dry oral mucosa. In addition, cellulose-based fibers are suitable for reducing odors, in particular they are applicable for the reduction or prevention of bad breath. Furthermore, proteins can be provided in very pure form for human and animal nutrition. The protein fractions obtained are particularly suitable for the formulation of food preparations and use, for example, in meat and sausage products, baking mixes, creams and beverages or in baby food or as/in enteral nutrition (tube feeding). Preference is given to the production and use of the protein fractions of/as hypoallergenic concentrate or protein isolates.

Preference is given to the production of GMO-free products obtainable from plant GMO-free starting material.

### EXAMPLES

The crude protein content of the samples was determined in accordance with LMBG § 3 5 L 03.00-27, via the nitrogen determination by the Dumas method. To convert the nitrogen content into the crude protein content of the samples, the factor 6.25 was used. The determination of nitrogen was carried out with the Leco system FP-528.

The water binding capacity (WBC) of the solid mater fractions was determined at room temperature: 2 g sample was weighed to the nearest 0.01 g into a centrifuge tube and mixed with 40 ml demineralized water for one minute with a test tube shaker. After 5 min and after 10 min, the mixture was vigorously mixed with the test tube shaker for 30 seconds. It was then centrifuged at 1000*g at 20° C. for 15 min. The supernatant was decanted. The centrifuge tube was reweighed. The weight of the water-saturated sample was determined.

The fat binding capacity of the solid matter fractions was determined at room temperature: 3 g were dispensing in a graduated 25 ml centrifuge tube in 20 ml of oil (commercial corn oil). It was then centrifuged at 700*g for 15 min. The volume of unbound oil was determined. The oil binding capacity is given in ml of oil/g sample. To determine protein solubility at a defined pH, the method according C. V. Morr was used. A 1 g sample was weighed and placed into a 100 ml beaker. With stirring, 40 ml of a 0.1 mol/l sodium chloride solution with a defoamer was added. The pH was adjusted to the desired value with a 0.1 mol/l hydrochloric acid or a 0.1 mol/l sodium hydroxide solution. The batch was transferred to a 50 ml volumetric flask and made up to the desired volume with 0.1 mol/l sodium chloride solution. From the solution, 20 ml were pipetted into a centrifuge tube and centrifuged for 15 min at 20,000*g. The resulting supernatant was filtered through a Whatman No. 1 filter. In the filtered supernatant, the nitrogen was determined according to Dumas (system Leco FP 521).

All investigations were performed under normal pressure conditions (101.3 Pa) and at room temperature (25° C.) unless otherwise stated.

### Example 1

Investigation on the Disintegration of Plant Cladding Material and Shells.

The following starting materials were used for the studies: 1) soybeans, 2) kidney beans, 3) almonds, 4) walnuts. The materials were without the outer shell (housing) (3) and 4)) and in dried form. 200 g each were placed in a vessel in which an aqueous solution without (a) or with one of the following substances dissolved herein was present: b) 0.1 molar sodium hydroxide solution, c) arginine 0.3 molar, d) SDS 1% by weight, e) lysine 300 mmol/l, f) histidine and glycine 300 mmol/l, g) RDG 0.3 molar. Every 10 minutes, individual beans/nuts were removed from the batches for analysis. The maximum exposure duration was 4 hours. The beans and nuts taken from the solutions were examined directly by incident light microscopy for perforations/dissolution of the cladding material. Furthermore, the peelability of the cladding material was examined by a manual tangential pressure on the cladding material and by a centered water jet at a pressure of 3 bar. Another portion of the beans and nuts was placed in a 25° C. water bath. It was in each case registered whether and to what extent the cladding material could be partly or completely detached or spontaneously detached. Furthermore, the consistency of the detached cladding material was investigated.

Results:

The cladding material of the beans or nuts had a clearly visible swelling after just a few minutes after being placed in the aqueous solutions of the test series c), e), f) and g), which continued to increase over the course of time, while this was only noticeable for pure water or in the test series b) and d) after 40 or 20 minutes. The visible swelling was associated with the ability to remove the cladding layers from the bean/nut surface. In the microscopic analysis of the cladding material, it was found that immersing of the starting materials into the aqueous solutions of the test series c), e), f) and g) resulted in to a superficial decomposition of the cladding material in the area of the seedling, which had a circular seam (1) appearance or had a longitudinal (2+3) orientation/progression, while this was undetectable after exposure to the other solutions. Over the course of time, there was a regular perforation of the cladding material with exposure of the bean/nut in these areas; the separated cladding materials exhibited similar geometries. The exposure in the test series b) resulted in a dark discoloration of the cladding material and/or of the exposed starting material.

By immersion in pure water, the cladding material did not spontaneously peeled off during the study period in any of the materials. Due to a tangential force, only small fragments could be detached at the end of the investigation. In the test series b) and d) a spontaneous and partial detachment of cladding material after 380 minutes or 400 minutes was recognizable. By a tangential force, a partial detachment of cladding material in series 1) and 3) after 180 or 240 minutes could be achieved and in series 2) and 4) after 280 or 360 minutes. Complete detachment was not possible. For the materials which had been introduced into the solutions c), e), f) and g), a spontaneous separation of the cladding material occurred after 30 to 100 minutes. For all preparations of series c), e), f) and g) a complete spontaneous separation could be achieved after 110 to 180 minutes. For these preparations, partial detachment by tangential pressure was possible for the first time after 10 to 20 minutes and complete detachment after 20 to 40 minutes. The cladding material obtained in test series b) and d) was not very elastic, regardless of the duration of exposure. The detached cladding material of the test series c), e), f) and g) was soft and flexible after an exposure time of 20 to 40 minutes and the material could pressed flat without tearing the cladding material.

### Example 2

Investigations on the Disintegration of Cladding Material and Separation of Sheaths and Seedlings.

For the investigations, a) soybeans, b) kidney beans and c) lentils were used, which were available as dried starting material. In the test series, aqueous solutions were used which 1) contained no substances or 2) NaOH 0.5% by weight, 3) sodium carbonate 1% by weight, 4) arginine 0.3 molar or 5) lysine isoleucine+DMSO 0.3 molar. In test series A), 100 g of each starting material was completely immersed into the solutions and the moment of a visible germ sprouting was determined by analysis of a continuous video recording as well as the moment when the germ reach a length of 5 mm. The duration of the experiment was limited to 72 hours. In test series B) 500 g of starting material was placed in water for the duration of time that led to a germinal growth of 5 mm and then portions of each 100 g thereof were placed in the aqueous test solutions 1) to 5). The materials were stored herein for the period of time which, according to the experimental procedure of Example 1, had given rise to a spontaneous perforation of the cladding material, with easy and complete separability of the cladding material. Then, half of the specimens were removed and placed in a filling device that ensured passage of the single specimens through a silicone tube by a jet of compressed air. The frequency of complete separation of the seedling and the cladding material was investigated. The test series C) was carried out with the starting materials of the test series B) left in the test solutions until a total immersion time of 48 hours in the test solutions was reached. During this period, a video was recorded to detect further growth in size of the seedlings. At the end of the investigation, a separation of the casings and seedlings with the stripping device was carried out analogously to the specimens of test series B). The completeness of separation of cladding material and seedlings was investigated and the length of the seedlings were compared with that of the test series B). Furthermore, the separated cladding materials were homogenized in a water bath using a shear mixer (UltraTurrax, T18, 20.00 rpm, 30 s) and then the resulting suspensions were tasted.

Results:

After immersion in water, the seed materials sprouted at about the same time in the respective starting materials with uniform growth of the seedlings. By immersion into the solutions 2) and 3), a delay of 12 or 18 hours was achieved in comparison to placement in pure water and after immersion in solution 5 for 30 hours. In solution 4), there was no (b) and c)) or very low growth of <5 mm in the starting materials in the given time. In test series B), there was a further growth of seedlings in the starting materials which, when stored in solutions 4) and 5), was strongly delayed to prevented. A complete stripping of the cladding material as well as of the seedlings was present in 36% and 28% of the beans and lentils after submersion in solutions 2) and 3). For specimens immersed into solutions 4) and 5), this was possible in 92% and 90%. In the case of specimens of test series C), a slight growth was detectable after immersion into solutions 2) and 3), whereas this was not recognizable in the case of specimens which had been immersed into solutions 4) and 5). The tasting of the suspensions gave an unpleasant and soapy taste when the starting material had been inserted in solutions 2) and 3) while the suspensions were practically tasteless after immersing of the starting materials in solutions 4) and 5).

### Example 3

Investigation of the Disintegration of Hydrated Starting Materials and Separability of Constituents.

The following starting materials were used for the investigations: 1. Pumpkin, variety Butternut, 2. Quince and 3. Celery. The materials were well cleaned and divided into 4 or 8 parts and placed in the following aqueous solutions: a) lysine 0.1 molar+urea 1 wt %, b) poly-arginine 0.1 molar+SDS, c) arginine 0.1 molar, d) histidine isoleucine 0.1 molar+sodium sulfite 1 wt %. As a reference, experiments were carried out with pure water, all other conditions being equal. The solutions were heated to 90° C. for 1 hour, then the inserted pieces of material were removed and allowed to cool. The peelability of the outer cladding layer was then examined. It was assessed whether the cladding material could be easily removed manually, with little attachment of the mesosperm and in large pieces. Further, the dispensability of the skinned material was examined by placing it in a vessel containing water in a weight ratio of 1:10 (material/water). Subsequently, dispensing was performed with a shear mixer (Silverson, L5M, UK, 35 mm/8000 rpm) for 30 seconds. Thereafter, the free water phase was removed from the suspensions by means of vacuum filtration. The pasty material was mixed in a volume ratio of 2:1 with pure water, passed through a sieve with a screen size of 0.8 mm and the free water phase was again removed. Immediately thereafter, a sensory evaluation was carried out by 4 experts. The presence of odor and taste qualities as well as the sensory properties in the mouth and during swallowing were evaluated.

Results: In the reference experiments, the outer coating layer could not be separated (material 3) and only in small pieces (especially material 2) as well as with distinct adhesions of the mesosperm. In the case of the materials which had been disintegrated in solutions a) to d), separation of the outer cladding layers was easy (b) and d)) to very easy (a)+c)). Correspondingly, medium sized or large and clumped pieces of cladding material were separated without attachment of the mesosperm. The skinned reference sample could not be completely comminuted, leaving a large amount of small clumps of aggregates in the sieve residue. The materials disintegrated with the solutions a)-d) were present in the form of a mush-like suspension, which passed the sieve, virtually residue-free. In the sensory evaluation, the pastes obtained from the reference samples had an intense odor and taste typical of the species. Furthermore, a dull (material 2) to grainy mouthfeel (especially material 3) was perceptible. In the samples obtained after disintegration with the solutions a) to d), no or practically no species-typical odor or taste was perceptible. In all cases, a pleasant mouthfeel, which was qualified as “soft” and “creamy”, was found. Particles were imperceptible.

### Example 4

Investigation for the Disintegration and Unlocking of Plant Cladding and Shell Material.

The following starting materials were used: 1. Soybean meal after hexane extraction, 2. Corn meal, 3. Apple pomace, 4. Grapeseed flour. Samples of 300 g each were placed in vessels containing a) pure water and the following aqueous solutions: b) histidine-valine-leucine 0.2 molar+sodium sulfite 1% by weight, c) arginine 0.1 molar, d) lysine 0.3 molar sodium bisulfite 0.5% by weight, e) sodium sulfite 0.5% by weight+sodium carbonate 0.1% by weight, in a weight ratio of (solid:water phase) 1:10. The containers were placed in an autoclave at a temperature of 125° C. and a pressure of 1.2 bar for 5, 15 and 30 minutes. After cooling, all of the suspensions were homogenized with a shear mixer (Silverson, L5M, UK; 35 mm/8,000 rpm) for 90 seconds. This was followed by wet screening with a vibrating sieve tower analyzer with sieve dimensions of 500 μm, 250 μm, 100 μm and 50 μm. The residual moisture content was determined from a sample of the sieve fractions and from this the dry masses of the individual sieve fractions were calculated. Furthermore, samples were taken for microscopic analysis. The samples were analyzed for the presence of recognizable cladding/shell structures and their relative proportions to fiber structures were calculated. Further, a chemical analysis was made to determine the content of soluble carbohydrates and proteins. An aqueous solution containing 10% by weight of citric acid and 10% by weight of calcium chloride was added to the water phases obtained after sieve separation, in a volume ratio of 1 to 3% by volume to adjust the pH of the process liquid to 4.8 to 5.4. After a stirring once the suspension was allowed to settle for 2 hours. Following this, a supernatant phase, which (if present) was not or only slightly turbid, was decanted and the sediment phase was passed onto a filter bed. After 10 hours, the dehydrated mass was removed from the filter and analyzed chemically for protein and carbohydrate content. There was also a tasting of these fractions. Furthermore, a sensory test according to Example 3 of the fiber masses of the individual sieve fractions was carried out after rinsing and removal of the free water phase by means of a sieve press.

Results: After only thermal disintegration in a water bath, predominantly large-caliber particles were present after homogenization, which was influenced only to a minor degree by the duration of the thermal exposure. In contrast, the particles, which were obtainable after disintegration using solutions b) to e), were considerably smaller already after a short heating period. Microscopic analysis revealed that after only thermal disintegration (a)) cladding material fragments or shell fragments were present in all samples in all time points and in all sieve fractions. In contrast, cladding material or shell fragments were only detectable to a small extent in the sieve fractions with a sieve size of >250 μm after disintegration using a short exposure time with solutions b) to e), and in samples which underwent a longer exposure duration cladding material or shell fragments were no longer present. While in the particle fractions obtained after a purely thermal disintegration, the predominant portion of the soluble carbohydrates and proteins which had been present in the starting materials was still present, only small to minimal amounts of soluble compounds were detectable in the particle fractions after unlocking with solutions b) to e). Accordingly, virtually no proteins or carbohydrates could be obtained from the aqueous filtrate by means of the aggregation initiation process after only thermal degradation. In contrast, the theoretically calculated amounts of proteins, resulting from the difference of amount of proteins according to quantitative analysis of the starting material minus the amount of proteins detected in the particles of the sieve fractions, could be recovered by the aggregation and dehydration method from the filtrate phases of the unlocking solutions b) to e). The protein/carbohydrate fractions obtained after unlocking with solutions b) to e) were virtually odorless and tasteless. While the fibers obtained by only thermal unlocking were still judged to be predominantly hard and fibrous during tasting, the fiber fractions obtained by disintegration with the solutions b) to e) were classified as soft to very soft, tender and creamy. In a microscopic analysis of the sieve residues after disintegration and unlocking with the solutions b) to e), it was found that the particles are large-volume fiber structures, which in further analyzes were revealed to be cellulose-based fibers.

### Example 5

Investigation of the Unlocking and Separability of Lignin-Rich Shell Constituents and Cellulose-Based Fibers.

An aqueous unlocking procedure was carried out on the press residues of jatropha kernels (JPK) and rapeseed (RPK). In this case, a separation of proteins and carbohydrates was carried out with an aqueous solution and the free water was removed from the solid fractions by means of a chamber filter press. The residue had a residual moisture of 40% by weight and an intense and unpleasant plant-typical odor (hence no tasting was performed). For the unlocking of the filter residue, 100 g of the crumbly residues were used in the following experiments, in which the following solutions were added and stirred continuously for 4 hours: 1. lysine 0.3 mol/l, 2. polyarginine+glutamine 0.2 mol/l, 3. histidine+RDG 0.2 mol/l, 4. NaOH 0.5N, 5. water. Subsequently, the solid matters were separated by means of a filter and rinsed twice with water on the filter. Thereafter, the samples were dispensed in 2 liters of tap water (city water) with a shear mixer for 60 seconds. From the agitated suspension after passing through a scalper with a sieve size of 500 μm by means of a pump, the suspensions were introduced into a hydrocyclone (Akavortex, AKW, Germany) at a differential pressure of 1 bar. The underflow was collected and mixed with tap water in a 1:5 ratio and recycled to the hydrocyclone. The upper run of both separation processes was freed from suspended solid matter by a vibrating sieve having a sieve mesh size of 100 μm to obtain the sieve residue 1 (SR 1). The underflow was separated from minute particles by a vibrating screen having a sieve mesh size of 200 μm to give sieve residue 2 (SR 2). The masses of lignin-rich shells (SR2) as well as a sample of the cellulose-based fibers of (SR1) were spread on a fine screen and dried by means of warm air. The remainder of the cellulose-based fibers was chilled to carry out further studies after removing the bound water by pressing. Samples were then taken for microscopic and chemical analysis. The dried SR2 was singulated by rolling. Samples were taken for microscopic and chemical analysis of the composition of the particles. To test the water binding capacity, 100 g of those sample were added to a narrow-base beaker, which had a lateral outlet in the bottom area. Water was added dropwise to the cladding material from the top until water emerged from the outlet. The weight ratio between the dry matter and the bound water was calculated. The same experiment was carried out with lamp oil instead of water, and the oil binding capacity was calculated accordingly. A sample of the SR1 was suspended in deionized water in a volume ratio of 1:10 for 3 minutes by stirring, and then the dimensions of the cellulose based fibers herein were determined with a FiberLab FS 300 (Valmet). The fractions obtained were examined by means of incident light microscopy for adherence of organic components (e.g., proteins), as well as the presence of agglomerates and caking of the fiber components as well as of other ingredients of the plant starting material.

Results:

The filter residue containing the solid matter obtained following an aqueous unlocking process could easily be resuspended and hydrated in water after disintegration with unlocking solutions 1)-3), which was evidenced by rapid spontaneous separation of the lignin-rich shell particles from the cellulose-based fibers, which sedimented rapidly, while the cellulose-based fibers had only a low sedimentation rate. Such behavior was not observed with the dispensed fiber fraction treated with solutions 4) and 5). By means of a hydrocyclone, a selectivity was obtained between cellulose-based fibers and liginin-rich shell particles, which was about 80% for the material obtained from the aqueous phase of the upper effluent and about 70% for the material obtained from the aqueous phase of the lower effluent, respectively, in the samples treated in the first separation with solutions 1)-3). After the 2nd separation of the individual solid phases, the separation result for both fractions was >95%. For the samples treated with solutions 4) and 5), separation to this extent was not possible or incomplete (<60% grade purity). Microscopically, no accumulations of organic constituents were detectable on the solid matter preparations obtained in the case of samples which had been treated with the unlocking solutions 1)-3), while the other samples had considerable deposits of organic materials and were present in the form of large aggregates in some cases. For the preparations treated with the unlocking solutions 1)-3), the water binding capacity of the dried lignin-rich shells was determined to be between 250 and 300% by weight and the oil binding capacity to be between 280 and 320% by weight, respectively. The corresponding water or oil binding capacities of fractions obtained with solutions 4) and 5) were <150% by weight and <120% by weight, respectively. For the dried cellulose-based fibers prepared with the unlocking solutions 1)-3), the water binding capacity ranged from 290 to 340% by weight and the oil binding capacity ranged from 220 to 310% by weight. For the fractions obtainable from a process with the solutions 4) and 5), the corresponding values were <100% by weight and <80% by weight.

The chemical analysis of the lignin-rich shell fractions obtained with the unlocking solutions 1)-3) resulted in a lignin content of between 52 and 73% by weight.

The volume dimensions of the cellulose-based fibers, which were resuspended after being obtained from this disintegration process showed that significantly larger volumes (+158 to +340 vol %) were present in cellulose-based fibers obtained after treatment with the unlocking solutions 1)-3) than after treatment with solutions 4) and 5).

The chemical analysis showed that the content of proteins or soluble carbohydrates present in the cellulose-based fibers and in the lignin-rich shell portions was <1% by weight after disintegration with the unlocking solutions 1) to 3), while the content of proteins and soluble carbohydrates in the others preparations was >10% by weight. In the sensory evaluation, fiber components treated with unlocking solutions 1) to 3) were found to be odorless and tasteless, while the other preparations had an unpleasant taste and smell.

### Example 6

Investigation of Unlocking Conditions in Plant Starting Materials.

The following press residues, which were in the form of pellets as well as milling products that were in the form of a flour, with the following contents of the ingredients were investigated: Soya cake (SPK): proteins 38% by weight, carbohydrates 26% by weight, fibers 21% by weight, oil 11% by weight, others 4% by weight; Rapeseed cake (RPK): proteins 35% by weight, carbohydrates 21% by weight, fibers 30% by weight, oil 9% by weight, others 5% by weight; Jatropha presscake (JPK): proteins 32% by weight, carbohydrates 22% by weight, fibers 25% by weight, oil 13% by weight, others 8% by weight; Oatmeal (HM): proteins 40% by weight, carbohydrates 30% by weight, fibers 18% by weight, oil 8% by weight, others 4% by weight; Lentil flour (LM): proteins 33% by weight, carbohydrates 33% by weight, fibers 25% by weight, oil 6% by weight, others 3% by weight. First the duration required for unlocking was determined by adding 50 g aliquots of the starting materials to flasks containing 1000 ml aqueous solutions of: a) arginine 0.2 molar, b) histidine and lysine each 0.1 molar, c) poly-arginine 0.1 molar and glutamic acid 0.1 molar, d) NH₃ 0.2 molar, e) KOH, 0.2 molar, f) urea 0.3 molar, g) sodium carbonate 0.5 wt %, h) sodium sulfite 0.2 wt % and mixed at a rate of 50/min. It was examined by observation at which point in time no more visible solid aggregates were present in the forming suspension. The respective suspensions were filtered at this moment of time through a vibrating sieve with a sieve mesh size of 100 μm and the filter residues were examined microscopically, according to Example 5. Then, a test was carried out to determine the minimum volume required for complete penetration and unlocking of the starting materials by adding to 100 g aliquots of the products, starting at a weight ratio of 1:1, a 50 ml increment of the unlocking solutions and the suspensions were slowly mixed over the period of time determined in the preliminary study required for complete unlocking for the respective unlocking solution. Samples were taken at the end of the respective minimum exposure time and centrifuged at 3,000 rpm for 3 minutes. A sufficient volume to produce complete swelling was determined as the mass ratio between the starting material and the unlocking solution (Pref), at which, after centrifugation of a sample, only a minimal free liquid layer was present as a supernatant. Then 10 g each of the batches, where a maximum achievable swelling could be achieved with the minimum required volume of the respective batches, was added to 90 ml of city water, dispensed by shaking and then the suspensions were passed through a vibrating sieve with a sieve mesh size of 100 μm. The eluate was passed through a 10 μm fine sieve. The respective filter residues were suspended in water and the particulate structures present therein were analyzed microscopically using identically performed filtration (test procedure according to Example 1). The sieve residues were dried during a repeat investigation and the weight of the retained particles was determined. In a further study, 100 g of the mass of the mixture Pref was admixed in 900 ml of water with a laboratory mixer for 5 minutes. The suspension was then passed through a vibrating screen. The bound water was removed from the sieve residue in a chamber filter press and the residual moisture content was determined. Then the press residue was suspended in a 0.5 molar NaOH solution and mixed for 1 hour. The suspension was again passed through the vibrating screen and the filter residue was dried with a chamber filter press.

Results:

Despite a significantly larger swelling volume which was present in a unlocking with the solutions a)-c), g) and h), compared to the solutions d)-f) (+160 up to +260 wt % vs. +80 up to +160% by weight) the time to achieve this was significantly shorter (8 to 20 minutes vs. 40 to 300 minutes). In the sieve residue (sieve mesh size 100 μm) after dispensing of the samples of the unlocking mixtures at the point of time of maximum swelling (Q max) in a dispensing volume which had been prepared by unlocking with the solutions a)-c), g) and h), microscopic analysis showed that there were no aggregates of the solid mater which was virtually free of adhering organic residues. In contrast to this, in the sieve residue after treatment with the unlocking mixtures, which had been prepared with the solutions d)-f), numerous aggregates/conglomerates of solid matter were present at the point of time Q max, some of which were completely surrounded by an organic mass. In contrast to the sieve residues of the samples which had been obtained with the solutions a)-c), g) and h), in which decompacted large-volume and expanded cellulose-based fibers were present, those were only isolated and slightly expanded detectable. On the ultrafine filter (sieve size 10 μm) of the eluate of the previously performed filtration, virtually no particulate structures were detectable after unlocking with the solutions a) to c), g) and h), whereas for the eluates resulting from unlocking with the solutions d) to f), numerous solid particles were present, which caused a layering of the filter surface; these particles were predominantly cellulose-based fibers which had a high adherance of organic compounds. The dry weight of the sieve residues after unlocking and dispensing of the soluble and dissolved constituents was significantly greater for the samples obtained from the unlocking with solutions d)-f) than for those obtained by unlocking with the solutions a)-c), g) and h) (+130 up to +350% by weight). By degradation of the sieve residue with an alkali lye the materials, which had been obtained after unlocking with the solutions a) to c), g) and h), released practically no more proteins, while in the sieve residue of the unlocking mixture by using with the solutions d) to f) between 8 and 22% by weight of proteins were dissolved out.

### Example 7

Investigation of Applications of Lignin-Based Plant Shell Material for Oil Binding The lignin-rich shell fractions obtained from experiment 5 (jatropha (JS), rapeseed (RS)) by the unlocking processes 1)-3), as well as a lignin-rich shell fractions of jatropha and rapeseed, in which a digestion with NaOH (NO) was carried out, air-dried and separated. The mean particle size distribution and the weight per volume were determined.

Into a 10 mm diameter glass tube having a conical tip at the bottom, which was closed by an open pore PP fabric, the dried cladding material was filled to a height of 20 cm. The weight of the filled shell mass was determined. For comparison, commercial oil sorbents (OAM1: Clean Sorb, BTW, Germany; OAM2: PEA SORB, Zorbit, Germany) were similarly filled into identical glass tubes. The filled glass tubes were mounted vertically in a holder with the tips of each immersed in a bath of sunflower oil and in another trial of oleic acid. Every 5 minutes the height of the oil front, which was clearly recognizable by a change in color, or the reflection of the adsorbent, was registered. The experiments were stopped after 2 h and the height of oil rise within the tubes (O-StH 1) and the difference of the volume of the oil bath to the starting volume (ads. Oil 1) determined. Subsequently, the complete contents of the riser pipes were carefully blown into a beaker and weighed. Thereafter, 100 ml of ethanol was added in each case. The suspensions were agitated with exclusion of air and heated to 60° C. with a magnetic stirrer for 30 minutes. Then the liquid phase was drained with a suction filter and 2 rinses (ethanol/H2O) of sieve residues of the shell or adsorbent masses were carried out, which was dried at 60° C. for 12 h thereafter. Then the weight and the consistency of the dried masses were determined/calculated (weight difference). Subsequently, the experiment was repeated with the obtained dried mass fractions and the oil front height (O-StH 2) and the volume of the adsorbed oil (ads. Oil 2) were determined/calculated again.

Results (Numerical Results in Table 1):

The lignin-based plant shells obtained and prepared with the unlocking solutions according to the invention had, in contrast to lignin-based shell fractions which had been purified with a lye, a very rapid and high absorption capacity for oils which was also better than that of commercial oil absorbers. This affected both the power of absorption against gravity and the total adsorbed volume. Purification of the adsorbed oils by a solvent was largely completely possible with the lignin-based plant shell fractions obtained with the unlocking solutions according to the invention, whereas in the case of lignin-rich shell fractions not obtained according to the invention, the adsorbed oil could not be removed completely. Even with the commercial products, the extraction of the adsorbed oil was incomplete. In a renewed cycle with the previously purified adsorbents the rate and amount of oil uptake in the lignin-rich shell fractions prepared with the unlocking solutions of this invention were comparable to that of the previously run experiment; however the oil adsorption performance of the remaining purified preparations remained well behind that obtained in the first cycle of use.

TABLE 1

| | O-StH 1 | Oil 1 | WD | O-StH 2 | Oil 2 |
|---|---|---|---|---|---|
| | (cm) | (ml) | (g) | (cm) | (ml) |
| JS | 6.4 | 3.1 | 3.1 | 6.4 | 3.1 |
| RS | 5.8 | 2.9 | 2.8 | 5.7 | 2.8 |
| SS | 5.2 | 2.8 | 2.7 | 5.2 | 2.7 |
| AS | 5 | 2.6 | 2.6 | 5.2 | 2.6 |
| JS-NO | 2.3 | 1.1 | 0.5 | 0.8 | 0.4 |
| RS-NO | 1.2 | 0.9 | 0.4 | 0.5 | 0.2 |
| ÖAM1 | 3.2 | 1.9 | 1.1 | 2.2 | 0.8 |
| ÖAM2 | 3.6 | 2.2 | 1.6 | 2.6 | 1.2 |

O-StH 1 = height of the oil front in the riser tube 1st cycle; ads.
Oil 1 = amount of adsorbed oil 1st cycle;
Weight Diff. = weight difference of adsorbents before/after solvent extraction;
O-StH 2 = height of the oil front in the riser tube 2nd cycle; ads.
Oil 2 = amount of adsorbed oil 2nd cycle;

### Example 8

Investigation of the Use of Lignin-Rich Plant Shells to Separate Oil from Oil-Containing Aerosols.

Lignin-rich plant shells of Jatropha (JKP) from Example 5, prepared with the unlocking solutions a) arginine 0.2 molar (JKPa) and d) NH₃ 0.2 molar (JKPd), were distributed between 2 sieve plates of 10×10 cm to a filling height of 2 cm; the sieves were then locked in a frame. The sieve frame was inserted into a ventilation shaft sealed laterally. A compressed air source ensured a constant air flow (70° C.) through the filter at a flow rate of 50 m³/h. An ultrasonic nebulizer was placed in the air stream which vaporized an oil-water emulsion at a constant rate. The pressure built up below the filter was monitored with a pressure transducer. Above the screen, the air outlet is via an oil mist separator (contec), which ensures 99.5% retention of oil from an air mixture. For comparison, conventional air filters (LF), steel mesh filters (SGF), activated carbon filters (AKF) and a membrane filter (MF) were mounted in the air duct in further experiments. The experiments were completed after 30 minutes, during which time an oil volume of 20 ml had been vaporized. Subsequently, the membrane filter was removed and the difference in weight to the initial value was determined. The lignin-rich shell fractions were removed from the filter housing and suspended in acetone in a beaker and the bound/adsorbed oil extracted. The separated acetone phases were evaporated and the residue was weighed. The oil separation rate was calculated from the weight difference of the oil adsorption material and the fog of the oil.

Results: When using a membrane filter and an activated carbon filter, there was an increase in pressure in the feeding duct (maximum pressure difference 35 or 52 mbar) due to an increase in air flow resistance. When using JKPd) there was initially a higher pressure than in experiments with lignin-rich shell fractions, which was obtained with the unlocking solutions according to the invention (JKPa). During the course of the experiment, there was also no pressure increase in the feed shaft, while the pressure on preparation JKPd) increased slightly. The oil separation rate in the conventional air filters was between 48 and 62% by weight. Lignin-rich shell fractions not produced according to the invention had an oil separation rate of 55% by weight, while the lignin-rich shell fractions which had been prepared with the unlocking solutions according to the invention had an oil separation rate of 98% by weight. From this fraction, 18.4 g of oil could be recovered by extraction, while in the preparation JKPd) only 5.2 g could be recovered.

### Example 9

Investigation of the Abrasive Cleaning Behavior of Lignin-Based Shell Material.

The shell fractions, which had been obtained in Example 5 from a rapeseed presscake unlocking with the unlocking solutions 1) and 2), were treated in a further disintegration/unlocking step using the following methods: 1) arginine 0.3 molar, 2) arginine 0.3 molar+urea 10% by weight, 3) arginine 0.1 molar+Na₂SO₃ 1% by weight, 4) NaOH 0.5 N, 5) water. The compounds were completely dissolved in a deionized water. Aliquots of 10 g of the shell fraction were suspended in 200 ml of the solutions and stirred for 20 minutes. Thereafter, the suspensions were treated in an autoclave at 120° C. at 2 bar for 11 minutes. Thereafter extensive rinsing with water over a sieve was performed. After pressing, drying and isolation of shell particles was done. Samples were taken for analysis. Then suspension of the shell fractions in a nonionic surfactant was performed. Then 2 ml of the surfactant solution including shell fractions were placed onto high gloss plastic on which various encrusted materials such as egg whites, sauces or pasta dough were present. A 500 g wooden punch which was moved by an automatic pusher was moved 30 times coaxially to the surface of the plastic sheets over the encrustations. Then the surfaces were rinsed off. After drying, the residual degree of soiling and the presence of scratches or furrows were evaluated.

Results: The microscopic analysis showed that the lignin-based shell components produced by methods 1 to 3 were completely separated and had significantly smaller surface dimensions than those of lignin-based shell materials obtained by methods 4 and 5. The shell fractions, which were manufactured according to the procedures 1 to 3, were predominantly rounded and had smooth outer contours. In the case of the shell fractions obtained with methods 4 and 5, predominantly sharp-edged and serrated outer contours were present.

For the surfaces treated with lignin-rich shell fractions prepared by methods 1 to 3, complete removal of the surface contaminants had been achieved, while for the shell fractions prepared according to methods 4 and 5 residues were still present. The surfaces cleaned with the lignin-rich shells prepared according to methods 1 to 3 were without scratch marks. Surfaces treated with shell fractions obtainable by methods 4 and 5 exhibited moderate to severe scratch marks.

### Example 10

Investigation of Unlocking Processes for the Recovery of Cellulose-Based Fibers

For each 1 kg of A) rapeseed press cake, B) corn grits, C) whole soybeans, D) sugar beet pulp after extraction of the molasses, the following experimental procedures were carried out: aqueous unlocking by placing materials A) and B) in a bath of unlocking compounds at a temperature of a) 25° C. and b) 60° C., in each case for 60 minutes under continuous stirring, c) furthermore by means of thermal disintegration materials C) and D) were immersed into the unlocking solutions in an autoclave at 125° C. for 15 minutes each. The following unlocking solutions were used: 1. water, 2. 0.1 N sodium hydroxide solution, 3. 30% sulfuric acid solution, 4. aqueous solution of arginine 0.3 molar, 5. aqueous solution of lysine 0.3 and glutamine 0.2 molar, 6. 1.5 wt % solution of sodium bisulfite, 7.5% by weight solution of sodium bicarbonate. Subsequently, the free water was removed from the resulting mixtures by centrifugation, so that they were present as dimensionally stable masses. To separate dissolved constituents, the masses were suspended in 10 l of water and finely dispensed with a stirrer for 10 minutes. Subsequently, the water phase was separated using a vibrating screen with a screen mesh size of 200 μm. From the fractions obtained, samples were taken for analysis. The drip-free masses were weighed and then dried in a drying oven. From the weight difference between the wet and dried mass, the water binding capacity was calculated. The wet samples were analyzed microscopically for the structure of the fibers as well as for the degree of adherence/clumping with other organic components. The obtained dry material was examined for the content of soluble carbohydrates and proteins. The number of fibers (pcs) per gram of wet mass, the maximum spatial extension and the aspect ratio were analyzed using a fiber analyzer (FiberLab FS300, Valmet).

Results:

An unlocking of the starting materials could not be achieved by the use of water. With lye, partial unlocking of the starting materials A) and B) was possible at room temperature, but not with unlocking solution 3. A substantial unlocking could be achieved with the unlocking solution 2. at elevated temperature (A) b) and B) b)) and thermal disintegration (C) and D)). Unlocking with a sulfuric acid solution was not possible under the experimental conditions. Unlocking solutions 4-7 achieved complete unlocking under all experimental conditions. In all samples in which macroscopically complete unlocking had not been achieved, the microscopic analysis showed the presence of solid particles and/or fibers that were partially combined with other organic constituents or components as well as the presence of caking with other fibers or organic compounds. In the chemical analysis, soluble carbohydrates and proteins in the sieve residue were detected in macroscopically incomplete unlocking. In the unlocking experiments, which were carried out with unlocking solutions 4-7, a macroscopically complete separation of constituents corresponding to non-cellulose-based fibers occurred in all experimental procedures (the filtrate solutions also passed through a sieve with a sieve mesh size of 20 μm without residue formation). The volume of the drip-free masses obtained after the unlocking processes with the unlocking solutions 4-7 was significantly greater than the volumes of the unlocking masses after carrying out the unlocking process with water or an alkali solution. Accordingly, the water binding capacity was significantly lower (80-190% by weight) in the obtained cellulose-based fibers of these processes than in the case of decompacted cellulose-based fibers obtained with the unlocking solutions 4-7 (680-850% by weight). Correspondingly, it was found in the chemical analyzes that in the resulting masses of cellulose-based fibers after use of the unlocking solutions 4-7 a residual content of soluble carbohydrates of <1 Gew % and of proteins of <0.5 wt % was present. In the other unlocking products, the levels of soluble carbohydrates and proteins were between 15 and 37% by weight. The dried aggregates of products with a residual content of >1% by weight of soluble carbohydrates and proteins were very firm and could only be partially hydrated. In contrast, aggregates obtained after drying from unlocking with unlocking solutions 4-7 were fully hydratable within 5 minutes. Grinding resulted in a powder that swelled rapidly in water and gave a soft fiber mass when free water was removed. Analysis of the dimensions and number of cellulose-based fibers made by unlocking with unlocking solutions 4-7 showed a broad and even distribution in a range between 20 μm and 600 μm with the number of fibers ranging from 550 to 237 pcs/g and having an aspect ratio of 2.5:1 to 22:1. The fiber length per weight was between 0.8 to 2.5 mg/100 m.

### Example 11

Investigation for the Production of Cellulose-Based Fibers from Mechanical Disintegration Processes

For the experiments, 1 kg of each of the following starting materials was used: A) soybean meal, B) oat flakes, C) grape seed flour.

The following process steps were carried out:

V1) Milling of the starting materials to a mean grain size of 100 μm. After this, airstream sorting with a fine classifier (Netsch CFS 5);

V2) milling of the starting products to a mean particle size of 100 μm. Thereafter, introduction into aqueous solutions in which the following compounds were in dissolved form: a) arginine 0.2 molar, b) histidine and lysine in each case 0.1 molar, c) poly-arginine 0.1 molar and glutamic acid 0.1 molar, d) NH₃ 0.2 molar, e) KOH, 0.2 molar, f) urea 0.3 molar, in a weight ratio of 1:1, so that the starting material completely immersed in the aqueous solution for 4 hours. Then the entire reaction mixture was rinsed with water in a volume ratio of 1:10 using a hand blender. The suspension was passed through a screen with a sieve mesh size of 200 μm. The sieve residue was rinsed twice with the same volume of a water phase and the sieve residue was then rolled out on a porous PP film in a layer thickness of 1 mm and dried. Subsequently, grinding of the dried masses was carried out.

V3) The starting materials are added to the following aqueous solutions in not further comminuted form: a) arginine 0.3 molar, b) polylysine 0.2 molar, c) polyglutamate 0.2 molar and histidine 0.4 molar, d) triethylamine 0.2 molar, e) NaOH 0.2 molar, f) sodium carbonate 0.3% by weight. The volume of the aqueous solutions added was restricted to the volume where complete impregnation/wetting of the starting material had just occurred. The batches were allowed to stand for 24 hours. Then the mixtures were stirred with water at a volume ratio of 1:10 using a hand blender. Thereafter, the suspensions were passed through a sieve with a sieve mesh size of 200 μm. The sieve residues were rinsed twice with the same volume of a water phase and the sieve residues were then rolled out on a porous PP film in a layer thickness of 1 mm and dried. Subsequently, grinding of the dried masses was carried out.

Of the dry masses respectively obtained, chemical analyzes were carried out on the content of soluble carbohydrates and proteins (according to Example 5). In each case 50 g of the powdered fiber masses obtained were solved in 500 ml of water at a temperature of 30° C. with continuous stirring for 1 hour. Of these, 100 ml were filled into a narrow-base graduated cylinder and the sedimentation time was determined in which the visible fibers had fallen below the 50 ml mark. Furthermore, samples were taken for an analysis of the fiber dimensions (analysis according to Example 6). The remaining suspension was concentrated, so as to achieve a residual moisture of 40-50 wt %. The resulting paste-like masses were tasted by 4 experts. The following properties were assessed: taste, graininess, mouthfeel, sensations during swallowing. Results: The fiber fractions of unlocking study V1 still contained larger amounts of soluble carbohydrates (24-36% by weight) and proteins (18-29% by weight). The fiber masses of unlocking studies V2 and V3, which had been prepared with the unlocking compounds a)-c), had residual contents of soluble carbohydrates and proteins of <0.5% by weight. After use of the other compounds (d)-f)) for unlocking, contents of soluble carbohydrates of 12-22 wt % and of proteins of 14-25 wt % were found in the resulting fiber masses. The fiber fraction obtained from unlocking study V1 was still compacted and only partially hydrated in water, and there was a very rapid sedimentation after filling into the graduated cylinder. The powdered fiber fractions prepared from unlocking studies V2 with unlocking compounds d)-f) were partially hydrated while the powdered fibers of unlocking experiment V3 conducted with unlocking compounds d)-f) were hardly hydratable. The determined sedimentation time at V2 was 15-25 minutes and at V3 4-10 minutes for unlocking products obtained with these unlocking compounds. In contrast, the powdered material of unlocking experiments V2 and V3 that were carried out with the unlocking compounds a)-c) were completely hydrated. The dissolved cellulose-based fibers of these unlocking fractions showed a very low sedimentation rate in a measuring cylinder, so that sedimentation of the dissolved cellulose-based fibers below the 50 ml mark only occurred after 12 to 27 hours. The fiber lengths averaged between 150 and 300 μm and the fiber width between 11 and 19 μm. The fiber weight per length (coarseness) was between 1.2 and 5.1 mg/100 m.

The tasting of the wet fiber material of unlocking study V1) revealed that there was a considerable amount of odorous and flavoring substances which corresponded to those of the starting materials. The fiber fraction of the unlocking studies V2 and V3, obtained with the unlocking compounds d)-f), also had, albeit to a lesser intensity, odors and flavors of the starting material. However, they were inedible due to an intense odor or taste of the related unlocking compound. In contrast, in the fiber fractions of unlocking studies V2 and V3 obtained with the unlocking compounds a)-c), no odor or flavor was present, so that the odor and taste were judged neutral. Furthermore, cellulose-based fibers obtained in the experiments V2 and V3 with the unlocking solutions a)-c) had no graininess, a more pleasant mouthfeel and pleasant swallowability.

### Example 12

Investigations Regarding the Production of Cellulose-Based Fibers from Organic Starting Materials.

The feasibility of manufacturing cellulose-based fibers that have a residual content of proteins and/or carbohydrates of <1% by weight and that do not release any odorants, flavorings or colorants to an aqueous medium was investigated with various pretreated starting materials.

Experimental series I. An organic mass, in which cellulose-based fibers were enriched after extraction of soluble proteins from soy beans and unpeeled kidney beans, was used. For preparation, the kernels, or unpeeled beans, were mechanically comminuted and placed in a solution of poly-arginine and histidine, or lysine and polyglutamate, for 4 and 8 hours, respectively. The organic mass, with a dry matter content of 40% by weight (DW), was suspended in water in a volume ratio of 1:10 or 1:5, followed by intense mixturing followed by filtration using a screen size of 100 μm. The screen residue consisted predominantly of cellulose-based fibers, but larger amounts of cladding materials as well as complex organic solids (starch granules) were also included herein. The fiber masses were dispensed in water in a volume ratio of 1:10 and transported by a pump through a hydrocyclone (Akavortex, AKW, Germany). The upper effluent was collected and filtered (sieve mesh size 50 μm) by means of a bow sieve. The sieve residue was analyzed.

Experimental series II. Thermally disintegrated plant material, in which cellulose-based fibers still formed large aggregates, was used for the unlocking process. Here, the starting materials were quince, carrots and celery, which had been subjected to thermal treatment in a waterbath at temperatures between 90° and 98° C. for 1 to 3 hours and comminuted with a hand-held food blender to a homogeneous mass. Aggregates of >2,000 μm accounted for >15% of the weight in the analysis. Furthermore, there was a species-typical smell and taste. The masses were dewatered by means of a chamber filter press to a residual moisture content of 50-80% by weight. The resulting masses were suspended in a weight ratio of 1:5 in an aqueous solution containing a) arginine 0.3 molar, b), poly-lysine, urea 10%), c) arginine 0.1 molar+Na₂SO₃ 10% and the suspension were placed in an autoclave for 8 and 16 minutes at a temperature of 120° C. The unlocking result was filtered and rinsed 2 times with copious amounts of water. From the final sieve residue, samples were taken for analysis.

Experimental series III. Mechanically disintegrated plant material with a high proportion of colorants was used. For this purpose, a puree of red beets, the fiber fraction from the unlocking of sunflower seed press cake with an arginine solution and the fiber fraction from an aqueous unlocking of a maize meal were used. The starting materials were first dehydrated to a residual moisture content of 40 to 70%. Then the masses were suspended in aqueous solutions containing a) poly-arginine, urea 5%; b) lysine 0.3 molar, SDS 2%, histidine 0.3 molar; c) arginine 0.1 molar, DMSO 2%, in a weight ratio of 1:5 to 1:10 with a hand-held blender. The suspensions were stirred in a series of experiments (T60) for 24 hours at 60° C. and treated in another test series (T120) for 8 minutes at 120° C. in an autoclave. The resulting suspensions were filtered and rinsed twice with water. Samples were taken for analysis from the final sieve residue.

Analyzed were the size distribution of the cellulose-based fibers, the content of proteins and soluble carbohydrates (according to Example 7), investigations on the solubility of colorants (testing by placing the test fraction in water and aqueous surfactant solutions for 48 hours with subsequent filtration and spectroscopic analysis of the filtrate) and a sensory evaluation by 4 experts according to the criteria of example 3.

Results:

Experimental Series I: The decompacted cellulose-based fibers separated by a cyclone separation technique were virtually without visible or measurable residues of cladding materials or aggregates of other constituents of the starting material, e.g. of starch granules. Furthermore, bulky fibers which had a narrower diameter spectrum with a fiber length of <1,000 microns in 98% and which was lower or narrower than was present in the starting material could be selectively obtained.

Experimental series II: The fiber analysis showed that the treatment resulted in a comminution of complexes of cellulose-based fibers and a decompaction, in which the diameter spectrum of fibers was clearly shifted to the left, particles with a diameter of >2,000 μm were not present or only comprised a fraction of <0.1%.

Experimental series III: From the masses of decompacted cellulose-based fibers obtained from both test series T60 and T120, no colorants were dissolved out by aqueous solutions.

The decompacted cellulose-based fibers obtained in the test series I to III had a protein and/or soluble carbohydrate content of <0.1% by weight.

All obtained cellulose-based fiber masses were found to be odorless and tasteless in the sensory examination. Furthermore, it was found for all preparations obtained that they are very soft when chewed, convey a pleasant mouthfeel and that there is no unpleasant sensation when swallowing the preparations.

### Example 13

Investigation into the Industrial Production of Baked Goods Made from/with Cellulose-Based Fibers.

The large-scale production of the following preparations was performed: A) chips, B) biscuits and C) gingerbread. Production of raw masses:

A) 100 kg decompacted cellulose-based fibers from soybean meal (prepared according to Example 11 (with an arginine solution)) having a moisture content of 70 wt % are mixed with 3 kg of a seasoning mix with an automatic kneading/stirring device over 2 hours to a homogeneous dough. The dough mass is pumped by means of a screw pump into a filling device, with which a defined volume of the mass is placed in the molds of a device. After filling, the mold is closed (sealed up) by a vapor permeable counterpart, thereby the dough masses are formed into 3 mm thin slices (diameter 5 cm) within the mold that is sealed up on all sides. Subsequently, the entire mold plate is heated to 140° C. for 5 minutes. The chips that fall out when the molds are opened are then conveyed on a belt into an oven in which they are heated to 180° C. for 2 minutes. The thereafter cooled chips are then packaged under an anhydrous nitrogen atmosphere, air- and vapor-tight. 31 kg of chips were obtained. A visual, tactile and sensory examination took place after storage periods of 2, 6 and 12 months. The appearance remained unchanged, as well as the fracture behavior and the surface texture. During the tasting, the consistency was rated crisp at all times point and a pleasant mouthfeel was indicated. There was no change in the taste characteristics over the course of storage.

B) 50 kg decompacted cellulose-based corn fibers (prepared according to Example 11 V2 b)) with a residual moisture content of <20 wt % are folded into a foam mass consisting of 40 kg of egg white and 10 kg egg yolk and 35 kg of powdered sugar and flavors, which were whipped together with 200 g sodium bicarbonate. The flowable dough was filled into bakeware (diameter of 30 cm) up to a height of 2 cm, and baked at 180° C. for 20 minutes. After cooling, the biscuit trays were detached and packed airtight and vapor-tight under a nitrogen atmosphere. Visual, tactile and sensory examinations were done after storage periods of 2, 6 and 12 months. The appearance remained unchanged, as well as the resistance to indentations and the surface texture. The consistency was judged to be slightly crisp at the tasting at all times, and the mouthfeel was stated to be soft and rounded. There was no change in the taste characteristics during the course of storage.

C) 50 kg of decompacted cellulose-based fibers of kidney beans (produced according to Example 12 V1) with a residual moisture content of <25% by weight was mixed with 50 kg of ground almonds, 10 kg of chopped candied lemon peel and orange peel and 500 g of sodium bicarbonate and a flavoring mixture. The mixture was kneaded under 60 kg of a mass made of eggs and powdered sugar. The dough was portioned after a rest period of 2 hours and rolled flat on baking trays to a height of 1 cm and baked at 180° C. for 20 minutes. After cooling, the dough portions were cut into pieces and packaged air- and vapor-tight. A visual, tactile and sensory examination was performed after storage periods of 2, 6 and 12 months. The appearance remained unchanged, as well as the resistance to indentations and the surface texture. The consistency was rated at all times as tender-crisp with a full mouthfeel. There was no change in appearance, resistance to indentations or taste properties during storage.

### Example 14

50 kg of soy extraction meal was soaked in a stirrer with 70 l of a 0.1 molar arginine solution using a spray device and allowed to stand for 1 hour after soaking. Subsequently, 70 l of water was admixed and then the water was removed from the mass using a filter press to achieve a residual moisture content of 60% by weight. The filter residue was suspended in 70l of a 0.5% by weight sodium sulfite solution and the mixture was placed in an autoclave for 10 minutes at a temperature of 128° C. at a pressure of 1.2 bar. Then the mixture was dewatered by means of a sieve press. The sieve residue was introduced into 200 l of a process water phase and dispensing by means of a shear mixer (Silverson L5M-A with a fine dispersing tool/10,000 rpm) for 10 minutes. Then centrifugal sieve filtration of the suspension was performed. The sieve residue is obtained as an odorless and tasteless creamy mass and functionalized with a nanoemulsion solution and then dried on a belt dryer. The dried cellulose-based fibers, which were in the form of thin platelets, were completely hydrated in water within 3 minutes and were then sensory soft and creamy. The filtrate phases from all steps were combined and then a 20% by weight solution of citric acid was admixed, which was distributed with low agitation. After 6 hours, the sediment phase was drained through a bottom drain of the container and passed onto a belt filter with a screen mesh size of 80 μm and the aggregate mass was then dewatered under continuous belt advancement. A creamy protein mass was obtained which could be completely dissolved in water and the resulting solution passed completely without a residue through a sieve with a mesh size of 10 μm. The protein mass was odorless and tasteless.

What is claimed is:

1. Process for the disintegration and unlocking of plant starting material with the process steps
a) providing a plant starting material,
b) adding a disintegration solution to the starting material and leaving it in the disintegration solution until disintegration,
c) dispensing of the constituents of the disintegrated starting material in a dispensing volume to obtain solid constituents and dissolved constituents of the plant-based starting material,
d) separation of solid constituents from dissolved constituents of the plant-based starting material,
e) obtaining the separated constituents of the plant-based starting material as materials for further utilization by,
e1) Fractionating of cellulose-based fibers from lignin-rich shells of the solid constituents of the plant-based starting material by means of an cyclone separation technique to obtain purified fractions of cellulose-based fibers and lignin-rich shells,
e2) aggregation/complexation of dissolved proteins of the dissolved constituents of the plant starting material by complexing agents and separation of the sedimented aggregated/complexed condensed proteins to obtain an aggregated/complexed protein mass.

2. The method according to claim 1, wherein the process step b) takes place together with a thermal and/or mechanical disintegration or a thermal and/or mechanical disintegration in a process step b1) takes place after the process step b).

3. The method according to claim 1, wherein the disintegration solution contains amino acids and/or peptides.

4. The method according to claim 1, wherein a decompaction of cellulose-based fibers and/or lignin-rich shells is prepared.

5. The method according to claim 1, in which a gentle product-sparing disintegration/perforation or detachment of cladding material of plant seeds, grains or kernels takes place.

6. The method according to claim 1 for producing of fiber products, from plant-based-cladding materials.

7. The method according to claim 1 for separating plant-based casing material while maintaining the structural integrity of the separated casing materials and/or the constituents of the seed (s), grains or kernels.

8. The method according to claim 1, wherein in addition to a disintegration and/or separation and/or dissolution of plant cladding materials, a separation of a seedling/sprout takes place.

9. The method according to claim 1, wherein it comes to slowing down/inhibiting of a ripening of plant-based seeds and/or grains.

10. The method according to claim 1, for the disintegration/dissolution/detachment of an intermediate layer between the plant-based cladding material and plant seeds, grains and kernels.

11. The method according to claim 1, wherein the low-odor and/or low-taste cladding materials and/or plant products are obtained.

12. The method according to claim 1, wherein the plant-based starting material is cladding material of plant seeds, grains or kernels.

13. The method according to claim 1, for the recovery of lignin-based cladding fractions and cellulose-based fibers.

14. The method according to claim 1, for the preparation of a plant-based cladding material preparation.

15. The method according to claim 1, for disintegration/unlocking of a homification of cellulose-based fibers.

16. The method according to claim 1, for obtaining a protein-containing sediment consisting of aggregated/complexed and condensed proteins.

17. Lignin-containing cladding material, obtainable by a process according to claim 1.

18. Lignin-rich cladding fractions and/or cellulose-based fibers, having an oil- and/or fat-binding capacity of >200% by weight, obtainable by a process according to claim 1.

19. Plant-based cladding material preparation, obtainable according to claim 14.

20.-21. (canceled)
